(19) United States
(12) Patent Application Publication
(10) Pub. No.: US 2023/0088781 A1
(43) Pub. Date: Mar. 23, 2023

(54) SECONDARY BATTERY, BATTERY PACK, VEHICLE, AND STATIONARY POWER SUPPLY

(71) Applicant: KABUSHIKI KAISHA TOSHIBA, Tokyo (JP)

(72) Inventors: Keigo HOSHINA, Yokohama (JP); Yasuyuki HOTTA, Tokyo (JP); Kazuomi YOSHIMA, Yokohama (JP); Shinsuke MATSUNO, Tokyo (JP); Norio TAKAMI, Yokohama (JP)

(73) Assignee: KABUSHIKI KAISHA TOSHIBA, Tokyo (JP)

(21) Appl. No.: 17/651,681

(22) Filed: Feb. 18, 2022

(30) Foreign Application Priority Data
Sep. 15, 2021 (JP) 2021-150356

(51) Int. Cl. H01M 50/534; H01M 4/485; H01M 4/66

(52) U.S. Cl. CPC H01M 50/534; H01M 4/485; H01M 4/668; H01M 2220/10; H01M 2220/20; H01M 2004/027

(57) ABSTRACT

According to one embodiment, a secondary battery includes positive electrodes, negative electrodes, a separator, a positive electrode lead, a negative electrode lead, and an aqueous electrolyte. The positive electrodes each include a positive electrode current collector and a positive electrode tab. The positive electrode current collector includes a first polymeric material. The negative electrodes each include a negative electrode current collector and a negative electrode tab. The negative electrode current collector includes a second polymeric material. At least a portion of the positive electrode tab is in direct contact with the positive electrode lead. At least a portion of the negative electrode tab is in direct contact with the negative electrode lead.

### CROSS-REFERENCE TO RELATED APPLICATIONS

This application is based upon and claims the benefit of priority from Japanese Patent Application No. 2021-150356, filed Sep. 15, 2021, the entire contents of which are incorporated herein by reference.

### FIELD

Embodiments described herein generally relate to a secondary battery, a battery pack, a vehicle, and a stationary power supply.

### BACKGROUND

A nonaqueous electrolyte battery which uses a carbon material or a lithium titanium oxide as a negative electrode active material and uses a layered oxide containing nickel, cobalt, manganese, and the like as a positive electrode active material, in particular, a lithium secondary battery, has already been in practical use as a power source in a wide range of fields. An organic solvent has been used as an electrolytic solution of such a nonaqueous electrolyte battery. In order to enhance the safety of the nonaqueous electrolyte battery, turning an organic solvent into an aqueous solution has been considered.

One of the problems with turning an organic solvent into an aqueous solution is that it causes side reactions such as oxidative-reductive decomposition of water. Such side reactions cause a decrease in the coulombic efficiency of the battery. Using a conductive resin sheet for a current collector of at least one of a positive electrode or a negative electrode to suppress side reactions has been considered.

A current collector made of a conductive resin sheet tends to have a larger resistance in the thickness direction than does a current collector made of metal, and thus has a drawback whereby a resistance at a portion where a stack of current collectors is electrically connected to another conductive member increases, resulting in an increase in the battery resistance.

### BRIEF DESCRIPTION OF THE DRAWINGS

FIG. 1 is a plan view schematically showing an example of a secondary battery according to an embodiment.

FIG. 2 is a cross-sectional view schematically showing a cross section of the secondary battery shown in FIG. 1, taken along a stacking direction of electrodes (z-axis direction).

FIG. 3 is a cross-sectional view schematically showing a cross section of a negative electrode of the secondary battery according to the embodiment, taken along the z-axis direction.

FIG. 4 is a plan view schematically showing the negative electrode shown in FIG. 3.

FIG. 5 is a cross-sectional view schematically showing a cross section of a positive electrode of the secondary battery according to the embodiment, taken along the z-axis direction.

FIG. 6 is a plan view schematically showing the positive electrode shown in FIG. 5.

FIG. 7 is a plan view schematically showing a positional relationship between a negative electrode lead and a negative electrode tab in another example of the secondary battery according to the embodiment.

FIG. 8 is a plan view schematically showing a positional relationship between a negative electrode lead and a negative electrode tab in another example of the secondary battery according to the embodiment.

FIG. 9 is a plan view schematically showing a positional relationship between a positive electrode lead and a positive electrode tab in another example of the secondary battery according to the embodiment.

FIG. 10 is a plan view schematically showing a positional relationship between a positive electrode lead and a positive electrode tab in another example of the secondary battery according to the embodiment.

FIG. 11 is a plan view schematically showing a positional relationship between a negative electrode lead and a negative electrode tab in still another example of the secondary battery according to the embodiment.

FIG. 12 is a plan view schematically showing a positional relationship between a negative electrode lead and a negative electrode tab in still another example of the secondary battery according to the embodiment.

FIG. 13 is a plan view schematically showing a positional relationship between a positive electrode lead and a positive electrode tab in still another example of the secondary battery according to the embodiment.

FIG. 14 is a plan view schematically showing a positional relationship between a positive electrode lead and a positive electrode tab in still another example of the secondary battery according to the embodiment.

FIG. 15 is a block diagram showing an example of an electric circuit of a battery pack according to an embodiment.

FIG. 16 is a cross-sectional view schematically showing an example of a vehicle according to an embodiment.

FIG. 17 is a block diagram showing an example of a system including a stationary power supply according to an embodiment.

FIG. 18 is a plan view schematically showing a secondary battery according to a comparative example.

FIG. 19 is a cross-sectional view schematically showing a portion where a tab and a lead of the secondary battery of the comparative example shown in FIG. 18 are connected to each other.

FIG. 20 is a cross-sectional view schematically showing a positional relationship between a negative electrode lead and a negative electrode tab in another example of the secondary battery according the embodiment.

### DETAILED DESCRIPTION

In general, according to an embodiment, a secondary battery including positive electrodes, negative electrodes, a separator, a positive electrode lead, a negative electrode lead, and an aqueous electrolyte is provided. The positive electrodes each include: a positive electrode current collector; a positive electrode tab extending, in a first direction, from at least one portion of an edge of the positive electrode current collector; and a positive electrode active material-containing layer provided on at least a portion of a surface of the positive electrode current collector. The positive electrode current collector includes a first conductive material and a first polymeric material. The negative electrodes each include: a negative electrode current collector; a negative electrode tab extending, in a second direction, from at least one portion of an edge of the negative electrode current collector; and a negative electrode active material-containing layer provided on at least a portion of a surface of the negative electrode current collector. The negative electrode current collector includes a second conductive material and a second polymeric material. The separator is arranged between the positive electrodes and the negative electrodes. At least a portion of the positive electrode tab of each positive electrode is in direct contact with the positive electrode lead. At least a portion of the negative electrode tab of each negative electrode is in direct contact with the negative electrode lead.

According to another embodiment, a battery pack is provided. The battery pack includes the secondary battery according to the embodiment.

According to another embodiment, a vehicle is provided. The vehicle includes the secondary battery according to the embodiment.

According to another embodiment, a stationary power supply is provided. The stationary power supply includes the secondary battery according to the embodiment.

Hereinafter, embodiments will be described while referring to the drawings where necessary. The same reference signs are applied to common components throughout the embodiments and repeat descriptions are thereby omitted. Each drawing is a schematic view for promoting descriptions and understanding of the embodiment, and there are thus some differences in shape, size, ratio and the like from those of a device actually used. They, however, can be appropriately design-changed with reference to the descriptions provided below and the known technology.

### First Embodiment

According to a first embodiment, a secondary battery including a plurality of positive electrodes, a plurality of negative electrodes, a separator, a positive electrode lead, a negative electrode lead, and an aqueous electrolyte is provided. The secondary battery according to the embodiment may be an alkali metal ion secondary battery such as a lithium ion secondary battery or a sodium ion secondary battery.

Each of the positive electrodes includes: a positive electrode current collector; a positive electrode tab (positive electrode current collecting tab); and a positive electrode active material-containing layer provided on at least a portion of a surface of the positive electrode current collector. The positive electrode current collector includes a first conductive material and a first polymeric material. The positive electrode tab extends from at least one portion of an edge of the positive electrode current collector, and extends along a first direction. Each of the negative electrodes include: a negative electrode current collector; a negative electrode tab (negative electrode current collecting tab); and a negative electrode active material-containing layer provided on at least a portion of a surface of the negative electrode current collector. The negative electrode current collector includes a second conductive material and a second polymeric material. The negative electrode tab extends from at least one portion of an edge of the negative electrode current collector, and extends along a second direction. The second direction may be the same as or different from the first direction. In order to prevent a short circuit from being caused by a contact between the negative electrode tab and the positive electrode tab, the second direction is preferably different from the first direction. The separator is arranged between at least one positive electrode of the positive electrodes and at least one negative electrode of the negative electrodes. The separator may be arranged between each of the positive electrodes and each of the negative electrodes. At least a portion of the positive electrode tab of each positive electrode is in direct contact with the positive electrode lead. The positive electrode tab may have a single extending portion or a plurality of extending portions. It suffices that at least a portion of a surface of the positive electrode tab is in direct contact with the positive electrode lead. At least a portion of the negative electrode tab of each negative electrode is in direct contact with the negative electrode lead. The negative electrode tab may have a single extending portion or a plurality of extending portions. It suffices that at least a portion of a surface of the negative electrode tab is in direct contact with the negative electrode lead.

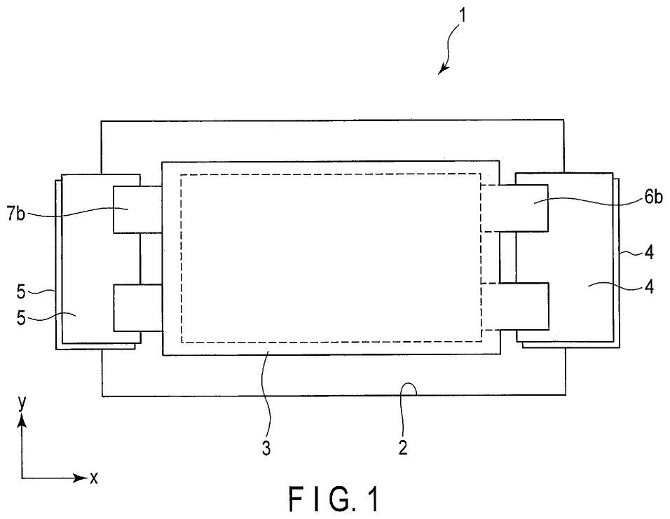

Examples of the secondary battery of the first embodiment will be described with reference to FIGS. 1 to 14 and FIG. 20.

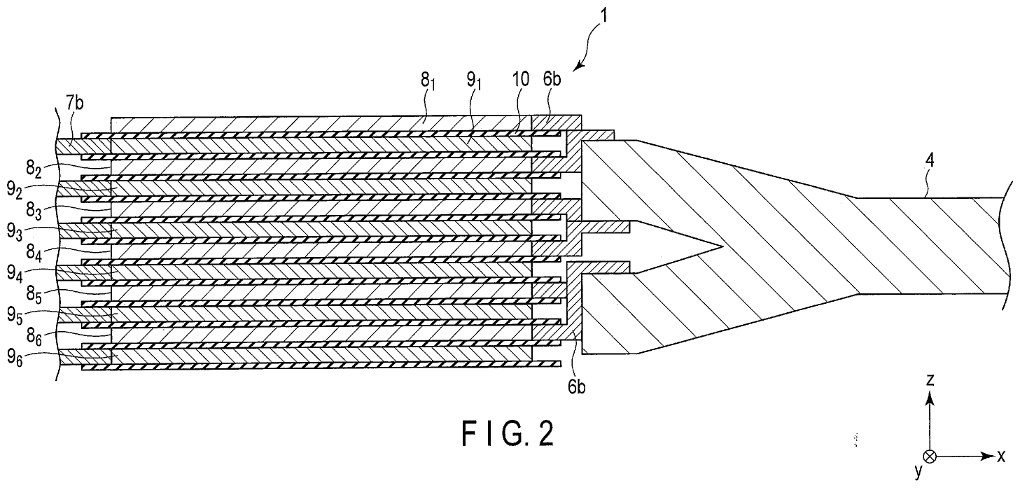

A secondary battery 1 shown in FIG. 1 includes a container member 2, an electrode group 3, a plurality of negative electrode leads 4, a plurality of positive electrode leads 5, a negative electrode tab 6b, and a positive electrode tab 7b. Each of the negative electrode leads 4 extends in the second direction along the x-axis direction, and a distal end of each of the negative electrode leads 4 projects outward from the container member 2. In FIG. 1, the second direction conforms to the x-axis direction and is opposite to the first direction, which will be described later. Each of the negative electrode leads 4 includes a first connection face along the xy plane and a second connection face opposite to the first connection face. As illustrated in FIG. 2, the plurality of negative electrode leads 4 overlap each other at the distal end thereof, and are electrically connected to each other by, for example, welding. On the other hand, each of the positive electrode leads 5 extends in the first direction, and a distal end of each of the positive electrode leads 5 projects outward from the container member 2. Each of the positive electrode leads 5 includes a first connection face along the xy plane and a second connection face opposite to the first connection face. The plurality of positive electrode leads overlap each other at the distal end thereof, and are electrically connected to each other by, for example, welding.

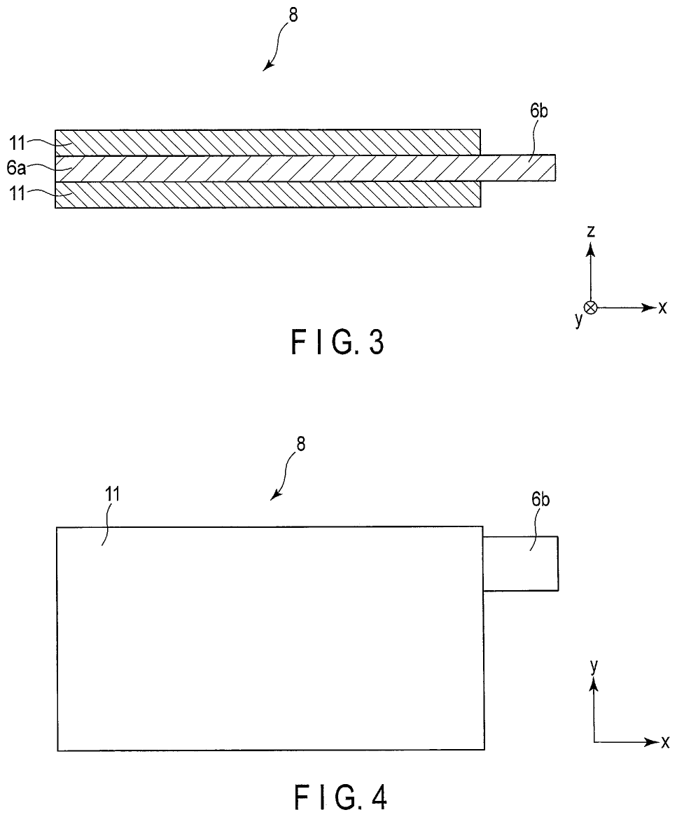

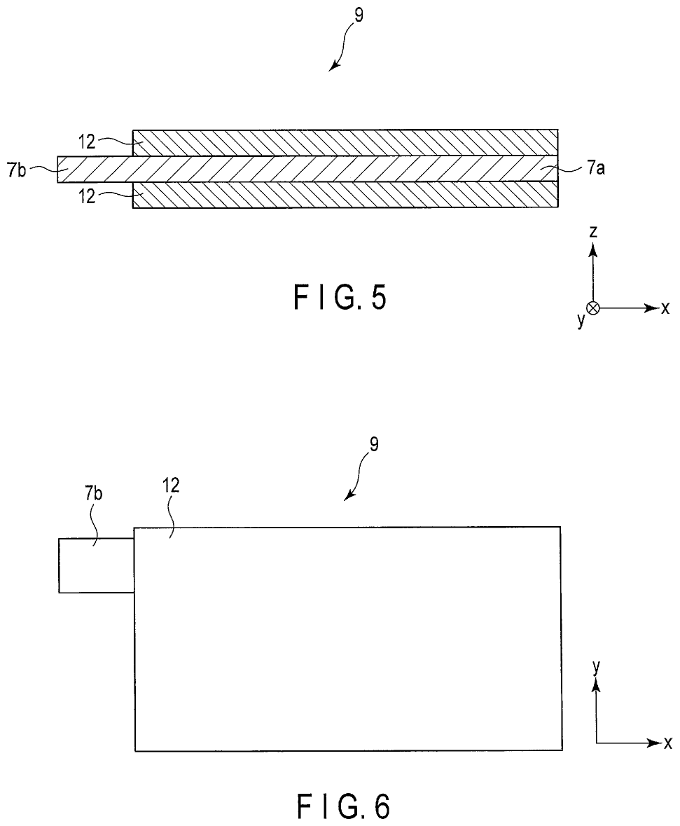

As illustrated in FIG. 2, the electrode group 3 includes a plurality of negative electrodes 8, a plurality of positive electrodes 9, and a plurality of separators 10. In FIG. 2, a main surface of each of the positive electrodes 9 and the negative electrodes 8 conforms to the xy plane, and a stacking direction of the positive electrodes 9, the negative electrodes 8, and the separators 10 conforms to the z-axis direction. An aqueous electrolyte (not shown) is held by the electrode group 3 (not shown). As illustrated in FIGS. 3 and 4, each of the negative electrodes 8 includes: a sheet-shaped negative electrode current collector 6a; a strip-shaped negative electrode tab 6b; and a negative electrode active material-containing layer 11. The strip-shaped negative electrode tab 6b extends, in the second direction along the x-axis direction, from one portion of an edge (e.g., an edge parallel to the short-side direction) of the negative electrode current collector 6a. The short-side direction conforms to the y-axis direction. The negative electrode active material-containing layer 11 is provided on a first main surface of the negative electrode current collector 6a along the xy plane and a second main surface opposite to the first main surface. The second direction conforms to the x-axis direction and is opposite to the first direction. In addition, as illustrated in FIGS. 5 and 6, each of the positive electrodes 9 includes: a sheet-shaped positive electrode current collector 7a; a strip-shaped positive electrode tab 7b; and a positive electrode active material-containing layer 12. The strip-shaped positive electrode tab 7b extends, in the first direction, from one portion of an edge (e.g., an edge parallel to the short-side direction) of the positive electrode current collector. The short-side direction conforms to the y-axis direction. The positive electrode active material-containing layer 12 is provided on a first main surface of the positive electrode current collector 7a and a second main surface opposite to the first main surface.

The negative electrodes 8, the positive electrodes 9, and the separators 10 are stacked in the z-axis direction so that each separator 10 is disposed between each negative electrode active material-containing layer 11 and each positive electrode active material-containing layer 12. For example, the separator 10 may form the outermost layer of the electrode group 3. The plurality of negative electrodes 8 are defined as a first negative electrode 8₁, a second negative electrode 8₂, a third negative electrode 8₃, a fourth negative electrode 8₄, a fifth negative electrode 8₅, and a sixth negative electrode 8₆, in order from the upper layer side. The negative electrode tabs 6b of the first negative electrode 8₁ and the second negative electrode 8₂ are directly connected to the first connection face of a negative electrode lead 4. As illustrated in FIG. 1, the negative electrode tab 6b of the first negative electrode 8₁ and the negative electrode tab 6b of the second negative electrode 8₂ are not physically connected to each other on the first connection face of the negative electrode lead 4. The negative electrode tabs 6b of the third negative electrode 8₃ and the fourth negative electrode 8₄ are directly connected to the second connection face of the negative electrode lead 4. The negative electrode tab 6b of the third negative electrode 8₃ and the negative electrode tab 6b of the fourth negative electrode 8₄ are not physically connected to each other on the second connection face of the negative electrode lead 4. The negative electrode tabs 6b of the fifth negative electrode 8₅ and the sixth negative electrode 8₆ are directly connected to the first connection face of another negative electrode lead 4. The negative electrode tab 6b of the fifth negative electrode 8₅ and the negative electrode tab 6b of the sixth negative electrode 8₆ are not physically connected to each other on the first connection face of the negative electrode lead 4.

The distal end of the negative electrode lead 4 is positioned outside the container member 2, but the portion of the negative electrode lead 4 connected to the negative electrode tabs 6b is positioned inside the container member 2.

The plurality of positive electrodes 9 are defined as a first positive electrode 9₁, a second positive electrode 9₂, a third positive electrode 9₃, a fourth positive electrode 9₄, a fifth positive electrode 9₅, and a sixth positive electrode 9₆, in order from the upper layer side. The positive electrode tabs 7b of the first positive electrode 9₁ and the second positive electrode 9₂ are directly connected to the first connection face of a positive electrode lead 5 (illustration omitted). As illustrated in FIG. 1, the positive electrode tab 7b of the first positive electrode 9₁ and the positive electrode tab 7b of the second positive electrode 9₂ are not physically connected to each other on the first connection face of the positive electrode lead 5. The positive electrode tabs 7b of the third positive electrode 9₃ and the fourth positive electrode 9₄ are directly connected to the second connection face of the positive electrode lead 5. The positive electrode tab 7b of the third positive electrode 9₃ and the positive electrode tab 7b of the fourth positive electrode 9₄ are not physically connected to each other on the second connection face of the positive electrode lead 5. The positive electrode tabs 7b of the fifth positive electrode 9₅ and the sixth positive electrode 9₆ are directly connected to the first connection face of another positive electrode lead 5. The positive electrode tab 7b of the fifth positive electrode 9₅ and the positive electrode tab 7b of the sixth positive electrode 9₆ are not physically connected to each other on the first connection face of the positive electrode lead 5.

The distal end of the positive electrode lead 5 is positioned outside the container member 2, but the portion of the positive electrode lead 5 connected to the positive electrode tabs 7b is positioned inside the container member 2.

In the secondary battery 1 configured as described above, the positive electrode current collector 7a and the positive electrode tab 7b each include a first conductive material and a first polymeric material. A material forming the positive electrode current collector 7a may be the same as or different from a material forming the positive electrode tab 7b. The negative electrode current collector 6a and the negative electrode tab 6b each include a second conductive material and a second polymeric material. A material forming the negative electrode current collector 6a may be the same as or different from a material forming the negative electrode tab 6b. Also, the first conductive material may be the same as or different from the second conductive material, and the first polymeric material may be the same as or different from the second polymeric material. Since the positive and negative electrode current collectors and the positive and negative electrode tabs include a conductive material and a polymeric material, side reactions due to electrolysis of water (oxidative-reductive decomposition of water) can be suppressed.

The negative electrode tabs 6b of the respective negative electrodes 8 are in direct contact with the first connection face or the second connection face of the negative electrode lead 4, and the positive electrode tabs 7b of the respective positive electrodes 9 are in direct contact with the first connection face or the second connection face of the positive electrode lead 5. Thus, all of the negative electrodes 8 are electrically connected to the negative electrode lead 4 via the negative electrode tabs 6b that are directly connected to the negative electrode lead 4. All of the positive electrodes 9 are also electrically connected to the positive electrode lead 5 via the positive electrode tabs 7b that are directly connected to the positive electrode lead 5. In other words, the secondary battery does not adopt the methods described in the comparative examples (which will be explained later), that is, the method in which the negative electrode tabs 6b overlapped with each other are bonded to the negative electrode lead 4 to thereby electrically connect the negative electrodes 8 to the negative electrode lead 4 and the method in which the positive electrode tabs 7b overlapped with each other are bonded to the positive electrode lead 5 to thereby electrically connect the positive electrodes 9 to the positive electrode lead 5; thus, the resistance of the secondary battery can be suppressed.

Accordingly, a secondary battery with few side reactions and low resistance can be provided.

FIGS. 1 and 2 show an example in which each negative electrode includes a single negative electrode tab and each positive electrode includes a single positive electrode tab; however, the number of negative electrode tabs of each negative electrode and the number of positive electrode tabs of each positive electrode are not limited to single but may be plural. Also, FIGS. 1 and 2 show an example in which a plurality of positive and negative electrode leads are provided; however, the number of positive electrode leads and the number of negative electrode leads may be single. This example, in which the number of negative electrode tabs of each negative electrode and the number of positive electrode tabs of each positive electrode are plural and the number of positive electrode leads and the number of negative electrode leads are single will be described below.

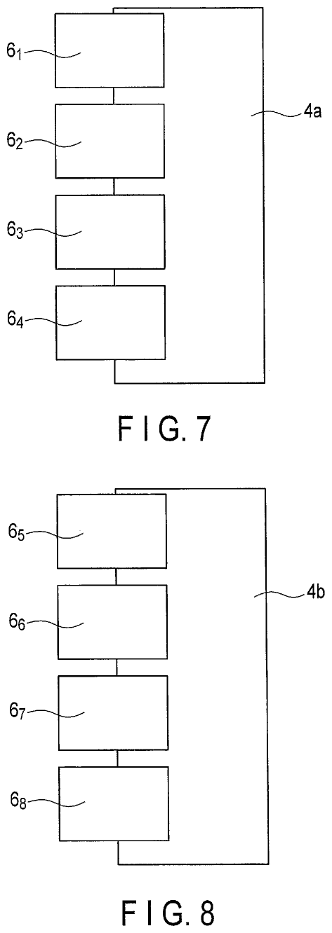

In the example shown in FIGS. 7 to 10, each negative electrode includes two negative electrode tabs, each positive electrode includes two positive electrode tabs, and a single positive electrode lead and a single negative electrode lead are provided. Since the configurations other than those shown in FIGS. 7 to 10 are the same as those shown in FIGS. 1 and 2, description thereof will be omitted.

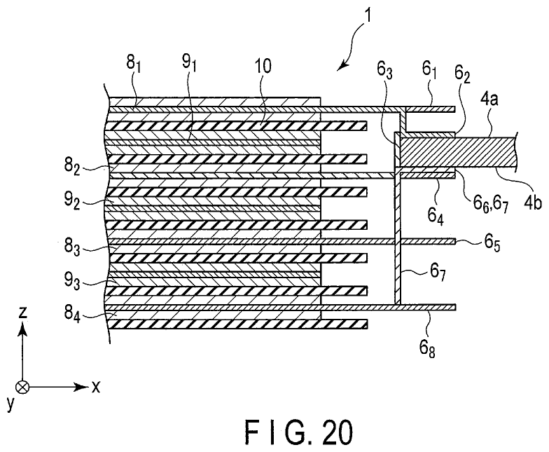

An electrode group 3 of the example shown in FIGS. 7 to 10 includes four negative electrodes 8 and three positive electrodes 9. Each negative electrode 8 includes two negative electrode tabs extending, in the second direction, from an edge parallel to the short-side direction of the negative electrode current collector 6a. The negative electrode tabs of the first negative electrode 8₁ are defined as a negative electrode tab 6₁ and a negative electrode tab 6₂; the negative electrode tabs of the second negative electrode 8₂ are defined as a negative electrode tab 6₃ and a negative electrode tab 6₄; the negative electrode tabs of the third negative electrode 8₃ are defined as a negative electrode tab 6₅ and a negative electrode tab 6₆; and the negative electrode tabs of the fourth negative electrode 8₄ are defined as a negative electrode tab 6₇ and a negative electrode tab 6₆. FIG. 20 is a cross-sectional view of the negative electrode tabs and the negative electrode lead shown in FIGS. 7 and 8, taken along the x-axis direction (viewed from the y-axis direction side). The z-axis direction in FIG. 20 is parallel to the direction in which the first negative electrode 8₁ to the fourth negative electrode 8₄ and the first positive electrode 9₁ to the third positive electrode 9₃ are stacked via the separator 10.

Each positive electrode 9 includes two positive electrode tabs extending, in the first direction, from an edge parallel to the short-side direction of the positive electrode current collector 7a. The positive electrode tabs of the first positive electrode 9₁ are defined as a positive electrode tab 7₁ and a positive electrode tab 7₂; the positive electrode tabs of the second positive electrode 9₂ are defined as a positive electrode tab 7₃ and a positive electrode tab 7₄; and the positive electrode tabs of the third positive electrode 9₃ are defined as a positive electrode tab 7₅ and a positive electrode tab 7₆.

As shown in FIG. 7, the negative electrode tab 6₁ of the first negative electrode 8₁, the negative electrode tab 6₂ of the first negative electrode 8₁, the negative electrode tab 6₃ of the second negative electrode 8₂, and the negative electrode tab 6₄ of the second negative electrode 8₂ are arranged on the upper side of the first connection face 4a of the negative electrode lead 4 with a space provided between each of the tabs. As shown in FIG. 20, the negative electrode tab 6₂ and the negative electrode tab 6₃ adjacent to each other are in contact with the first connection face 4a of the negative electrode lead 4 and are bonded to the first connection face 4a of the negative electrode lead 4 by, for example, thermal fusion bonding. As shown in FIG. 20, the negative electrode tab 6₁ and the negative electrode tab 6₄ positioned with the negative electrode tab 6₂ and the negative electrode tab 6₃ interposed therebetween are not in contact with the first connection face 4a of the negative electrode lead 4. In this manner, there may be a negative electrode tab among the plurality of negative electrode tabs that is not in contact with the negative electrode lead.

As shown in FIG. 8, the negative electrode tab 6₅ of the third negative electrode 8₃, the negative electrode tab 6₆ of the third negative electrode 8₃, the negative electrode tab 6₇ of the fourth negative electrode 8₄, and the negative electrode tab 6₈ of the fourth negative electrode 8₄ are arranged on the upper side of the second connection face 4b of the negative electrode lead 4 (i.e., the lower side in FIG. 20) with a space provided between each of the tabs. As shown in FIG. 20, the negative electrode tab 6₆ and the negative electrode tab 6₇ adjacent to each other are in contact with the second connection face 4b of the negative electrode lead 4 and are bonded to the second connection face 4b of the negative electrode lead 4 by, for example, thermal fusion bonding. As shown in FIG. 20, the negative electrode tab 6₅ and the negative electrode tab 6₈ positioned with the negative electrode tab 6₆ and the negative electrode tab 6₇ interposed therebetween are not in contact with the second connection face 4b of the negative electrode lead 4.

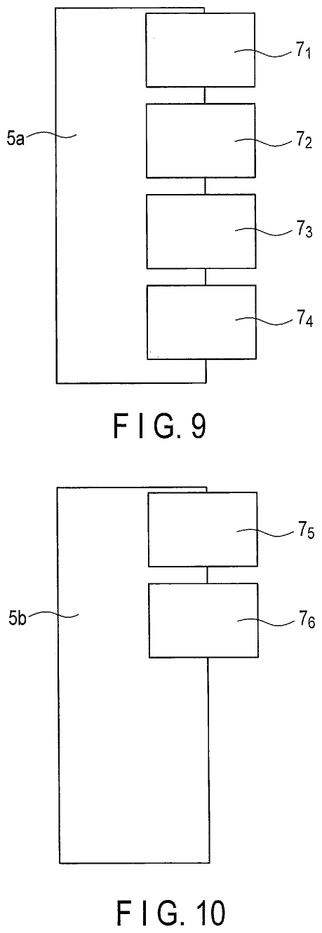

With regard to the positive electrode, the positive electrode tab 7₁ of the first positive electrode 9₁, the positive electrode tab 7₂ of the first positive electrode 9₁, the positive electrode tab 7₃ of the second positive electrode 9₂, and the positive electrode tab 7₄ of the second positive electrode 9₂ are arranged on the upper side of the first connection face 5a of the positive electrode lead 5 with a space provided between each of the tabs, as shown in FIG. 9. The positive electrode tab 7₂ and the positive electrode tab 7₃ adjacent to each other with a space therebetween are bonded onto the first connection face 5a of positive electrode lead 5 by, for example, thermal fusion bonding. The positive electrode tab 7₁ and the positive electrode tab 7₄ positioned with the positive electrode tab 7₂ and the positive electrode tab 7₃ interposed therebetween are not in contact with the first connection face 5a of the positive electrode lead 5.

As shown in FIG. 10, the positive electrode tab 7₅ and the positive electrode tab 7₆ of the third positive electrode 9₃ are arranged on the upper side of the second connection face 5b of the positive electrode lead 5 with a space provided between the tabs. The positive electrode tab 7₆ is bonded onto the second connection face 5b of the positive electrode lead 5 by, for example, thermal fusion bonding. On the other hand, the positive electrode tab 7₅ is not in contact with the second connection face 5b of the positive electrode lead 5.

According to the configuration described above, all of the negative electrodes 8 are electrically connected to the negative electrode lead 4 by the negative electrode tabs 6₂, 6₃, 6₆, and 6₇ that are directly connected to the negative electrode lead 4. All of the positive electrodes 9 are also electrically connected to the positive electrode lead 5 by the positive electrode tabs 7₂, 7₃, and 7₆ that are directly connected to the positive electrode lead 5. Thus, the battery resistance can be suppressed.

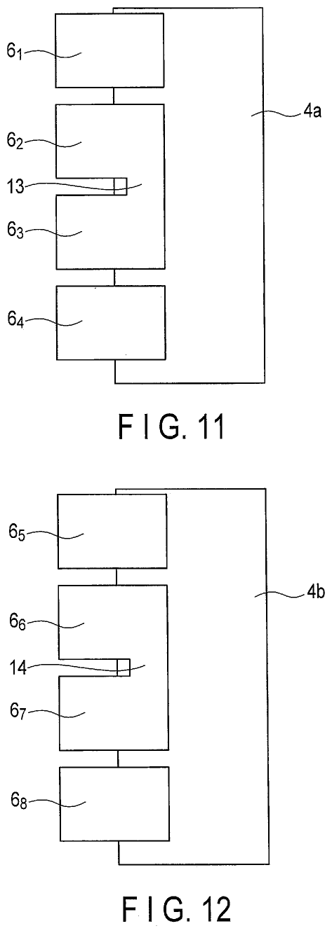

Next, the example shown in FIGS. 11 to 14 will be described. In the example shown in FIGS. 11 to 14, the positive electrode tabs and the negative electrode tabs, which are in contact with the positive electrode lead and the negative electrode lead, respectively, are electrically connected to each other. Since the arrangement of the positive and negative electrode leads and the positive and negative electrode tabs in the example shown in FIGS. 11 to 14 is the same as that shown in FIGS. 7 to 10, description thereof will be omitted.

The arrangement of the negative electrode tab 6₁, negative electrode tab 6₂, negative electrode tab 6₃, negative electrode tab 6₄, negative electrode tab 6₅, negative electrode tab 6₆, negative electrode tab 6₇, and negative electrode tab 6₈ shown in FIGS. 11 and 12 is the same as the example shown in FIGS. 7 and 8. A first connecting portion 13 is provided between the negative electrode tab 6₂ and the negative electrode tab 6₃ adjacent to each other. A second connecting portion 14 is provided between the negative electrode tab 6₆ and the negative electrode tab 6₇ adjacent to each other. The first connecting portion 13 forms a conductive path directly connecting the negative electrode tab 6₂ and the negative electrode tab 6₃. On the other hand, the second connecting portion 14 forms a conductive path directly connecting the negative electrode tab 6₆ and the negative electrode tab 6₇.

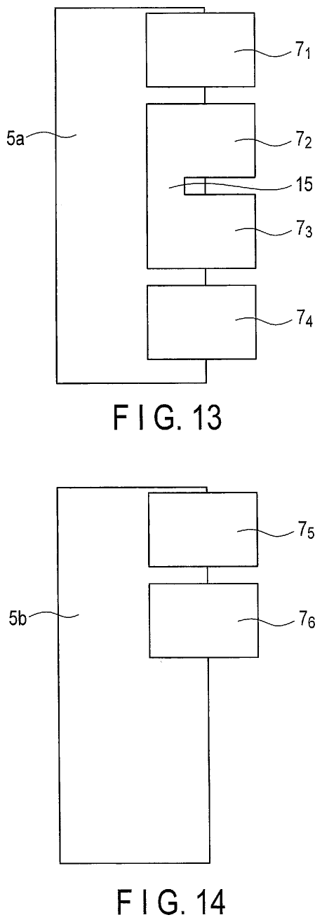

The arrangement of the positive electrode tab 7₁, positive electrode tab 7₂, positive electrode tab 7₃, positive electrode tab 7₄, positive electrode tab 7₅, and positive electrode tab 7₆ shown in FIGS. 13 and 14 is the same as the example shown in FIGS. 9 and 10. A third connecting portion 15 is provided between the positive electrode tab 7₂ and the positive electrode tab 7₃. The third connecting portion 15 forms a conductive path directly connecting the positive electrode tab 7₂ and the positive electrode tab 7₃.

According to the configuration described above, the negative electrode tabs 6b of the respective negative electrodes 8 are directly connected to the negative electrode lead 4. The positive electrode tabs 7b of the respective positive electrodes 9 are directly connected to the positive electrode lead 5. The negative electrode tabs electrically connected to different negative electrodes are electrically connected to each other by the connecting portion as well as by the negative electrode lead 4. The positive electrode tabs electrically connected to different positive electrodes are electrically connected to each other by the connecting portion as well as by the positive electrode lead 5. Thus, reduction of the battery resistance can be further promoted.

The configurations of the first connecting portion to the third connecting portion are not particularly limited as long as it enables an electrical connection between the electrode tabs. Examples of such a configuration include: overlapping a portion of one of the adjacent electrode tabs with the other of the adjacent electrode tabs to bring it into contact with the other of the adjacent electrode tabs; bonding the electrode tabs to each other by thermal fusion bonding; and bonding the electrode tabs to each other with a conductive adhesive. In the case of overlapping a portion of one of the adjacent electrode tabs with the other of the adjacent electrode tabs to bring them into contact with each other, the overlapping area is set to about 20% or less of the area of one of the electrode tabs.

Hereinafter, each member included in the secondary battery will be described.

(1) Positive Electrode

The positive electrode includes: a positive electrode current collector; a positive electrode tab (or positive electrode current collecting tab); and a positive electrode active material-containing layer provided on at least one of the main surfaces of the positive electrode current collector. The positive electrode current collector includes a first conductive material and a first polymeric material. The positive electrode tab extends, along a first direction, from at least one portion of an edge of the positive electrode current collector. The positive electrode active material-containing layer includes a positive electrode active material. The positive electrode active material-containing layer may further include a conductive agent and a binder. The conductive agent is added, as necessary, to enhance current collecting performance and to suppress a contact resistance between the active material and the current collector. The binder functions to bind the active material, the conductive agent, and the current collector.

The positive electrode current collector may be a conductive sheet that includes a first conductive material and a first polymeric material. Examples of the first polymeric material that can be used include polyethylene, polypropylene, polyethylene terephthalate, polyacrylonitrile, polymethylmethacrylate, and polyvinylidene fluoride. A conductive filler such as a carbonaceous material is preferably used as the first conductive material. Examples of the carbonaceous material that can be used include carbon black, ketjen black, graphite, fibrous carbon, and carbon nanotubes. One, or two or more kinds of the first conductive material and the first polymeric material may be used.

The content of the first conductive material in the positive electrode current collector may be 10% by mass to 90% by mass. If the content of the first conductive material is insufficient, necessary conductivity cannot be obtained. If the content of the first conductive material is too large, an unfavorable situation such as a crack or a chip being easily generated in the current collector will occur.

The content of the first polymeric material in the positive electrode current collector may be 10% by mass to 90% by mass. If the content of the first polymeric material is insufficient, the amount of a binder component included in the current collector will be small, resulting in an occurrence of an unfavorable situation, such as a crack or a chip being easily generated in the current collector. If the content of the first polymeric material is too large, the resistance of the current collector is increased.

The positive electrode current collector may be a conductive resin sheet that includes the first polymeric material as a matrix component and the first conductive material (for example, made of a conductive filler) mixed into the matrix component.

The positive electrode current collector can be produced by, for example, an extrusion molding method such as a T-die method or an inflation method, a calender method, or the like.

The thickness of the positive electrode current collector is preferably 5 μm or more and 20 μm or less, and more preferably 15 μm or less.

The positive electrode tab may be integral with the positive electrode current collector. For example, the positive electrode tab may be made of the same material as that of the positive electrode current collector.

A compound having a lithium ion insertion/extraction potential of 3 V (vs.Li/Li⁺) to 5.5 V (vs.Li/Li⁺) as a potential based on metal lithium can be used as the positive electrode active material. The positive electrode may contain one kind of positive electrode active material or two or more kinds of positive electrode active materials.

Examples of the positive electrode active material include a lithium manganese composite oxide, a lithium nickel composite oxide, a lithium cobalt aluminum composite oxide, a lithium nickel cobalt manganese composite oxide, a spinel-type lithium manganese nickel composite oxide, a lithium manganese cobalt composite oxide, a lithium iron oxide, a lithium fluorinated iron sulfate, and a phosphate compound having an olivine crystal structure (e.g., LiₓFePO₄ (0<x≤1), LiₓMnPO₄ (0<x≤1)). The phosphate compound having an olivine crystal structure has excellent thermal stability.

Examples of the positive electrode active material that enables attainment of a high positive electrode potential include: lithium manganese composite oxides such as LiₓMn₂O₄ (0<x≤1), LiₓMnO₂ (0<x≤1) having a spinel structure; lithium nickel aluminum composite oxides such as LiₓNi_{1-y}Al_{y}O₂ (0<x≤1, 0<y<1); lithium cobalt composite oxides such as LiₓCoO₂ (0<x≤1); lithium nickel cobalt composite oxides such as LiₓNi_{1-y-z}Co_{y}Mn_{z}O₂ (0<x≤1, 0<y<1, 0≤z<1); lithium manganese cobalt composite oxides such as LiₓMn_{y}Co_{1-y}O₂ (0<x≤1, 0<y<1); spinel-type lithium manganese nickel composite oxides such as LiₓMn_{1-y}Ni_{y}O₄ (0<x≤1, 0<y<2, 0<1-y<1); lithium phosphorus oxides having an olivine structure such as LiₓFePO₄ (0<x≤1), LiₓFe_{1-y}Mn_{y}PO₄ (0<x≤1, 0≤y≤1), LiₓCoPO₄ (0<x≤1); and iron sulfate fluoride (e.g., LiₓFeSO₄F (0<x≤1)).

The positive electrode active material is preferably at least one selected from the group consisting of a lithium cobalt composite oxide, a lithium manganese composite oxide, and a lithium phosphorus oxide having an olivine structure. The operating potentials of these active materials are from 3.5 V (vs.Li/Li⁺) to 4.2 V (vs.Li/Li⁺). That is, the operating potentials of these active materials are relatively high. When these positive electrode active materials are used in combination with a negative electrode active material such as a spinel-type lithium titanate listed above, a high battery voltage can be obtained.

The positive electrode active material is included in the positive electrode in the form of particles, for example. The positive electrode active material particles may be discrete primary particles, secondary particles as an agglomerate of primary particles, or a mixture of primary particles and secondary particles. The shape of the particles is not particularly limited, and may be, for example, a spherical shape, an elliptical shape, a flat shape, a fibrous form, or the like.

The average particle size (diameter) of the primary particles of the positive electrode active material is preferably 10 μm or less, and more preferably 0.1 μm to 5 μm. The average particle size (diameter) of the secondary particles of the positive electrode active material is preferably 100 μm or less, and more preferably 10 μm to 50 μm.

In the positive electrode active material-containing layer, the positive electrode active material and the binder are preferably blended in proportions of 80% by mass to 98% by mass, and 2% by mass to 20% by mass, respectively.

When the amount of the binder is 2% by mass or more, sufficient electrode strength can be achieved. The binder may serve as an insulator. Thus, when the amount of the binder is 20% by mass or less, the amount of an insulator included in the electrode is reduced, allowing for a decrease in the internal resistance.

When a conductive agent is added, the positive electrode active material, the binder, and the conductive agent are preferably blended in proportions of 77% by mass to 95% by mass, 2% by mass to 20% by mass, and 3% by mass to 15% by mass, respectively.

When the amount of the conductive agent is 3% by mass or more, the above-described effects can be achieved. When the amount of the conductive agent is 15% by mass or less, the proportion of the conductive agent that comes into contact with an electrolyte can be decreased. If said proportion is low, decomposition of the electrolyte can be reduced during storage under high temperature.

(2) Positive Electrode Lead

The positive electrode lead is not particularly limited as long as it is electrically conductive, but it may be made of, for example, metal, an alloy, a carbonaceous material, or the same material as that of the positive electrode current collector.

Examples of the positive electrode lead include one that includes at least one selected from the group consisting of Ti, stainless steel, Al, and a carbonaceous material, and one that is made of the same material as that of the positive electrode current collector.

(3) Negative Electrode

The negative electrode includes: a negative electrode current collector; a negative electrode tab; and a negative electrode active material-containing layer provided on at least one of the main surfaces of the negative electrode current collector. The negative electrode current collector includes a second conductive material and a second polymeric material. The negative electrode tab extends, along a second direction which may be different from a first direction, from at least one portion of an edge of the negative electrode current collector. The negative electrode active material-containing layer contains a negative electrode active material.

The negative electrode current collector may be a conductive sheet that includes a second conductive material and a second polymeric material. Examples of the second polymeric material that can be used include polyethylene, polypropylene, polyethylene terephthalate, polyacrylonitrile, polymethylmethacrylate, and polyvinylidene fluoride. A conductive filler such as a carbonaceous material is preferably used as the second conductive material. Examples of the carbonaceous material that can be used include carbon black, ketjen black, graphite, fibrous carbon, and carbon nanotubes. One, or two or more kinds of the second conductive material and the second polymeric material may be used.

The content of the second conductive material in the negative electrode current collector may be 10% by mass to 90% by mass. If the content of the second conductive material is insufficient, necessary conductivity cannot be obtained. If the content of the second conductive material is too large, an unfavorable situation such as a crack or a chip being easily generated in the current collector will occur.

The content of the second polymeric material in the negative electrode current collector may be 10% by mass to 90% by mass. If the content of the second polymeric material is insufficient, the amount of a binder component included in the current collector will be small, resulting in an occurrence of an unfavorable situation, such as a crack or a chip being easily generated in the current collector. If the content of the second polymeric material is too large, the resistance of the current collector is increased.

The negative electrode current collector may be a conductive resin sheet that includes the second polymeric material as a matrix component and a filler (for example, made of the second conductive material) mixed into the matrix component.

The negative electrode current collector can be produced by, for example, an extrusion molding method such as a T-die method or an inflation method, a calender method, or the like.

The thickness of the negative electrode current collector is preferably 5 μm to 50 μm. A current collector having such a thickness can maintain a balance between the strength and weight reduction of the electrode.

The negative electrode tab may be integral with the negative electrode current collector. For example, the negative electrode tab may be made of the same material as that of the negative electrode current collector.

A compound having a lithium ion insertion/extraction potential of 1 V (vs.Li/Li⁺) to 3 V (vs.Li/Li⁺) as a potential based on metal lithium can be used as the negative electrode active material.

Specifically, a titanium oxide or a titanium-containing oxide may be used as such a compound. Examples of the titanium-containing oxide that may be used include a lithium titanium composite oxide, a niobium titanium composite oxide, and a sodium niobium titanium composite oxide. The negative electrode active material may include one, or two or more kinds of titanium oxides and titanium-containing oxides.

The titanium oxides include, for example, a titanium oxide having a monoclinic structure, a titanium oxide having a rutile structure, and a titanium oxide having an anatase structure. The composition of the titanium oxides having these crystal structures before charging can be represented by TiO₂, and the composition thereof after charging can be represented by LiₓTiO₂ (x is 0≤x≤1). The structure of the titanium oxide having a monoclinic structure before charging can be represented by TiO₂(B).

Examples of the lithium titanium oxide include: lithium titanium oxides having a spinel structure (e.g., Li₄₊ₓTi₅O₁₂ (x is −1≤x≤3)); and lithium titanium oxides having a ramsdellite structure (e.g., Li₂₊ₓTi₃O₇ (−1≤x≤3)), Li₁₊ₓTi₂O₄ (0≤x≤1), Li_{1.1+x}Ti_{1.8}O₄ (0≤x≤1), Li_{1.07+x}Ti_{1.86}O₄ (0≤x≤1), and LiₓTiO₂ (0<x≤1)). The lithium titanium oxides may be lithium titanium composite oxides including a different element.

The niobium titanium composite oxide includes, for example, a compound represented by LiₐTiM_{b}Nb_{2±β}O_{7±σ} (0≤a≤5, 0≤b≤0.3, 0≤β≤0.3, 0≤σ≤0.3, and M is at least one element selected from the group consisting of Fe, V, Mo and Ta).

The sodium titanium composite oxide includes, for example, orthorhombic Na-containing niobium titanium composite oxides represented by Li_{2+V}Na_{2-W}M1_{X}Ti_{6-y-z}Nb_{y}M2_{z}O_{14+δ} (0≤v≤4, 0≤w<2, 0≤x<2, 0≤y<6, 0≤z<3, −0.5≤δ≤0.5, M1 includes at least one selected from Cs, K, Sr, Ba, and Ca, and M2 includes at least one selected from Zr, Sn, V, Ta, Mo, W, Fe, Co, Mn, and Al).

As the negative electrode active material, a titanium oxide having an anatase structure, a titanium oxide having a monoclinic structure, a lithium titanium oxide having a spinel structure, or a mixture thereof is preferably used. When one of these oxides is used as the negative electrode active material and also in combination with, for example, a lithium manganese composite oxide as the positive electrode active material, a high electromotive force can be obtained.

The negative electrode active material is contained in the negative electrode active material-containing layer in the form of, for example, particles. The negative electrode active material particles may be primary particles, secondary particles as an aggregate of primary particles, or a mixture of discrete primary particles and secondary particles. The shape of the particles is not particularly limited, and may be a spherical shape, an elliptical shape, a flat shape, a fibrous form, or the like.

The average particle size (diameter) of the primary particles of the negative electrode active material is preferably 3 μm or less, and more preferably 0.01 μm to 1 μm. The average particle size (diameter) of the secondary particles of the negative electrode active material is preferably 30 μm or less, and more preferably 5 μm to 20 μm.

The negative electrode active material-containing layer may include a conductive agent, a binder, and the like in addition to the negative electrode active material. The conductive agent is added, as necessary, to enhance current collecting performance and to suppress a contact resistance between the active material and the current collector. The binder functions to bind the active material, the conductive agent, and the current collector.

Examples of the conductive agent include carbonaceous materials such as acetylene black, ketjen black, graphite, and coke. A single kind of conductive agent, or a mixture of two or more kinds of conductive agents may be used.

The binder is added to fill gaps among the dispersed active material and to bind the active material with the negative electrode current collector. Examples of the binder include polytetrafluoroethylene (PTFE), polyvinylidenefluoride (PVdF), fluororubber, styrene-butadiene rubber, a polyacrylic acid compound, an imide compound, carboxymethylcellulose (CMC), and salts of CMC. One of these may be used as the binder, or two or more of these may be used in combination as the binder.

The blending ratio of the conductive agent and the binder in the negative electrode active material-containing layer is in a range of 1 part by weight to 20 parts by weight, preferably in a range of 0.1 parts by weight to 10 parts by weight, with respect to 100 parts by weight of the active material. When the blending ratio of the conductive agent is 1 part by weight or more, the conductivity of the negative electrode can be favorable. When the blending ratio of the conductive agent is 20 parts by weight or less, decomposition of an aqueous electrolyte on the surface of the conductive agent can be reduced. When the blending ratio of the binder is 0.1 part by weight or more, sufficient electrode strength can be achieved. When the blending ratio of the binder is 10 parts by weight or less, an insulation portion of the electrode can be reduced.

The crystal structure and the elemental composition of the positive electrode active material and the negative electrode active material can be confirmed by powder X-ray diffraction (XRD) measurement and inductively coupled plasma (ICP) emission spectroscopy.

(4) Negative Electrode Lead

The negative electrode lead is not particularly limited as long as it is electrically conductive, but it may be made of, for example, metal, an alloy, a carbonaceous material, or the same material as that of the negative electrode current collector.

Examples of the negative electrode lead include one that includes at least one selected from the group consisting of Al, Zn, Sn, Ni, Cu, and a carbonaceous material, and one that is made of the same material as that of the negative electrode current collector.

(5) Aqueous Electrolyte

The aqueous electrolyte includes an aqueous solvent and an electrolyte salt. The aqueous electrolyte is, for example, a liquid. The liquid aqueous electrolyte is an aqueous solution prepared by dissolving an electrolyte salt as a solute in an aqueous solvent. When the aqueous electrolyte is held in both the negative electrode active material-containing layer and the positive electrode active material-containing layer, the type of the aqueous electrolyte held in the negative electrode active material-containing layer may be the same or different from the type of the aqueous electrolyte held in the positive electrode active material-containing layer.

The amount of the aqueous solvent in the aqueous solution is preferably 1 mol or more, and more preferably 3.5 mol or more with respect to 1 mol of salt as a solute.

A solution containing water can be used as the aqueous solvent. The solution containing water may be pure water or a mixed solvent of water and an organic solvent. For example, the aqueous solvent contains water in a proportion of 50% by volume or more.

The inclusion of water in the aqueous electrolyte can be confirmed by gas chromatography-mass spectrometry (GC-MS) measurement. The salt concentration and the water content in the aqueous electrolyte can be measured by, for example, inductively coupled plasma (ICP) emission spectrometry. The molar concentration (mol/L) can be calculated by measuring a predetermined amount of aqueous electrolyte and calculating the concentration of contained salt. In addition, the molar number of the solute and the solvent can be calculated by measuring the specific weight of the aqueous electrolyte.

The aqueous electrolyte may be a gel electrolyte. The gel electrolyte is prepared by mixing the above-described liquid aqueous electrolyte and a polymeric compound to form a composite thereof. Examples of the polymeric compound include polyvinylidenefluoride (PVdF), polyacrylonitrile (PAN), and polyethylene oxide (PEO).

For example, a lithium salt, a sodium salt, or a mixture thereof can be used as an electrolyte salt. One, or two or more kinds of electrolyte salts may be used.

For example, the following can be used as the lithium salt: lithium chloride (LiCl); lithium bromide (LiBr); lithium hydroxide (LiOH); lithium sulfate (Li₂SO₄); lithium nitrate (LiNO₃); lithium acetate (CH₃COOLi); lithium oxalate (Li₂C₂O₄); lithium carbonate (Li₂CO₂); lithiumbis(trifluoromethanesulfonyl)imide (LiTFSI; LiN(SO₂CF₃)₂); lithiumbis(fluorosulfonyl)imide (LiFSI; LiN(SO₂F)₂); and lithiumbisoxalateborate (LiBOB: LiB[(OCO)₂]₂).

The lithium salts preferably include LiCl. When LiCl is used, the concentration of lithium ions in the aqueous electrolyte can be increased. Also, the lithium salts preferably include at least one of LiSO₄ and LiOH in addition to LiCl.

For example, the following can be used as the sodium salt: sodium chloride (NaCl); sodium sulfate (Na₂SO₄); sodium hydroxide (NaOH); sodium nitrate (NaNO₃), and sodium trifluoromethanesulfonylamide (NaTFSA).

The molar concentration of alkali metal ions (e.g., lithium ions) in the aqueous electrolyte may be 3 mol/L or more, 6 mol/L or more, and 12 mol/L or more. As an example, the molar concentration of alkali metal ions in the aqueous electrolyte is 14 mol/L or less. If the concentration of alkali metal ions in the aqueous electrolyte is high, electrolysis of the aqueous solvent in the negative electrode is easily suppressed, and generation of hydrogen from the negative electrode is less likely to occur.

The aqueous electrolyte preferably includes, as anion species, at least one selected from chlorine ion (Cl⁻), hydroxide ion (OH⁻), sulfate ion (SO₄²⁻), and nitrate ion (NO₃⁻).

The pH of the aqueous electrolyte is preferably 3 to 14, and more preferably 4 to 13. When different electrolytes are used for the electrolyte on the negative electrode side and the electrolyte on the positive electrode side, the pH of the electrolyte on the negative electrode side is preferably in a range of 3 to 14, and the pH of the electrolyte on the positive electrode side is preferably in a range of 1 to 8.

When the pH of the electrolyte on the negative electrode side is in the above range, the potential for generating hydrogen in the negative electrode is decreased, leading to suppression of hydrogen generation in the negative electrode. Thus, the storage performance and the cycle life performance of the battery are improved. When the pH of the electrolyte on the positive electrode side is in the above range, the potential for generating oxygen in the positive electrode is increased, resulting in reduction of oxygen generation in the positive electrode. Thus, the storage performance and the cycle life performance of the battery are improved. The pH of the electrolyte on the positive electrode side is more preferably in a range of 3 to 7.5.

The aqueous electrolyte may include a surfactant. Examples of the surfactant include non-ionic surfactants such as polyoxyalkylene alkyl ether, polyethylene glycol, polyvinyl alcohol, thiourea, 3,3′-dithiobis(1-propane sulfonic acid)2 sodium, dimercaptothiadiazole, boric acid, oxalic acid, malonic acid, saccharin, sodium naphthalenesulfonate, gelatin, potassium nitrate, aromatic aldehyde, and heterocyclic aldehyde. The surfactant may be used in a single form or in the form of a mixture of two or more kinds thereof.

(6) Separator

The separator is disposed, for example, between the positive electrode and the negative electrode. The separator may be one that covers only one of the positive electrode or the negative electrode.

The separator may have a porous structure. Examples of the porous separator include a non-woven fabric, film, and paper. Examples of a material constituting the porous separator that forms a non-woven fabric, film, paper and the like include polyolefins, such as polyethylene and polypropylene, and cellulose. Preferred examples of the porous separator include a non-woven fabric including cellulose fibers and a porous film including polyolefin fibers.

The porous separator preferably has a porosity of 60% or more. The porous separator also preferably has a fiber diameter of 10 μm or less. When the porous separator has a fiber diameter of 10 μm or less, the compatibility of the porous separator to the electrolyte is improved, allowing for a decrease in the battery resistance. A more preferred range of fiber diameter is 3 μm or less. A cellulose fiber-containing non-woven fabric having a porosity of 60% or more exhibits favorable impregnation performance for an electrolyte, and can exhibit high output performance ranging from a low temperature to a high temperature. A more preferred range of porosity is 62% to 80%.

The porous separator preferably has a thickness of 20 μm to 100 μm, and preferably has a density of 0.2 g/cm³ to 0.9 g/cm³. In these ranges, it is possible to maintain a balance between a mechanical strength and reduction of a battery resistance, and provide a high-output secondary battery with an internal short-circuit suppressed. Also, heat shrinkage of the separator is less likely to occur in a high-temperature environment, allowing for attainment of favorable high-temperature storage performance.

A composite separator that includes a porous separator and a layer formed on one side or both sides of the porous separator and containing inorganic particles may be used as the separator. Examples of the inorganic particles include aluminum oxide and silicon oxide.

A solid electrolyte layer may be used as the separator. The solid electrolyte layer may include solid electrolyte particles and a polymeric component. The solid electrolyte layer may be made only of solid electrolyte particles. The solid electrolyte layer may include one kind of solid electrolyte particles or more than one kind of solid electrolyte particles. The solid electrolyte layer may include at least one selected from the group consisting of a plasticizer and an electrolyte salt. For example, when the solid electrolyte layer includes an electrolyte salt, the alkali metal ion conductivity of the solid electrolyte layer can be further enhanced. The polymeric material may be, for example, in a granular form or a fibrous form.

The solid electrolyte layer is preferably sheet-shaped with few or no pinhole-like pores. The thickness of the solid electrolyte layer is not particularly limited, but is, for example, 150 μm or less, and preferably in a range of 20 μm to 50 μm.

The polymeric component used in the solid electrolyte layer is preferably a polymeric component insoluble in an aqueous solvent. Examples of the polymeric component satisfying this condition include polyethylene terephthalate (PET), polypropylene (PP), polyethylene (PE), and a fluorine-containing polymeric component. By using a fluorine-containing polymeric component, the separator can have water-repellent properties. Also, an inorganic solid electrolyte has a high stability against water and has excellent lithium ion conductivity. By combining an inorganic solid electrolyte having lithium ion conductivity and a fluorine-containing polymeric component to form a composite, a solid electrolyte layer with alkali metal ion conductivity and flexibility can be realized. The separator made of said solid electrolyte layer can reduce resistance, and thus can improve the large-current performance of the secondary battery.

Examples of the fluorine-containing polymeric component include polytetrafluoroethylene (PTFE), polychlorotrifluoroethylene (PCTFE), ethylene-tetrafluoroethylene copolymer, and polyvinylidene fluoride (PVdF). One, or two or more kinds of fluorine-containing polymeric components may be used.

When the solid electrolyte layer contains a polymeric component, a proportion of the polymeric component contained in the solid electrolyte layer is preferably 1% by weight to 20% by weight. In this range, a high mechanical strength can be achieved when the solid electrolyte layer has a thickness of 10 μm to 100 μm, and the resistance can be reduced. Furthermore, there is a low possibility that the solid electrolyte will be a factor of inhibiting lithium ion conductivity. A more preferred range of the proportion is 3% by weight to 10% by weight.

As the solid electrolyte, an inorganic solid electrolyte is preferably used. An inorganic solid electrolyte is, for example, an oxide-based solid electrolyte or a sulfide-based solid electrolyte. A lithium phosphate solid electrolyte having a NASICON-type structure and represented by LiM₂(PO₄)₃ is preferably used as the oxide-based solid electrolyte. M in this general formula is preferably at least one element selected from the group consisting of titanium (Ti), germanium (Ge), strontium (Sr), zirconium (Zr), tin (Sn), and aluminum (Al). The element M more preferably includes Al and any one of Ge, Zr, and Ti.

A specific example of the lithium phosphate solid electrolyte having a NASICON-type structure is LATP (Li₁₊ₓAlₓTi₂₋ₓ(PO₄)₃), Li₁₊ₓAlₓGe₂₋ₓ(PO₄)₃, Li₁₊ₓAlₓZr₂₋ₓ(PO₄)₃. The symbol x in said formulae is in a range of 0<x≤5, and is preferably in a range of 0.1≤x≤0.5. LATP is preferably used as the solid electrolyte. LATP has excellent water resistance and is less likely to cause hydrolysis in the secondary battery.

Further, as the oxide-based solid electrolyte, amorphous LIPON (Li_{2.9}PO_{3.3}N_{0.46}) or LLZ having a garnet-type structure (Li₇La₃Zr₂O₁₂) may be used.

(7) Container Member

As the container member, a metallic container, a container made of a laminated film, or a container made of resin, for example, may be used. As the metallic container, a metal made of nickel, iron, stainless steel and the like and having a prismatic and cylindrical shape may be used. As the container made of resin, a container made of polyethylene, polypropylene or the like may be used.

The thickness of the laminated film is, for example, 0.5 mm or less, and preferably 0.2 mm or less.

As the laminated film, a multilayer film including multiple resin layers and a metal layer interposed between the resin layers is used. The resin layer includes, for example, a polymeric material such as polypropylene (PP), polyethylene (PE), nylon, or polyethylene terephthalate (PET). The metal layer is preferably made of an aluminum foil or an aluminum alloy foil, for reduction in weight. The laminated film may be formed into the shape of the container member by heat-sealing.

The wall thickness of the metallic container is, for example, 1 mm or less, more preferably 0.5 mm or less, and still more preferably 0.2 mm or less.

The metallic container is made, for example, of aluminum, an aluminum alloy, or the like. The aluminum alloy preferably contains an element such as magnesium, zinc, and/or silicon. If the aluminum alloy contains a transition metal such as iron, copper, nickel, and/or chromium, the content thereof is preferably 100 ppm by mass or less.

The shape of the container member is not particularly limited. The shape of the container member may be, for example, flat (thin), prismatic, cylindrical, coin-shaped, button-shaped, or the like. The container member can be suitably selected depending on the size of the battery or the intended use of the battery.

The secondary battery according to the embodiment may be used in various shapes such as a prismatic shape, a cylindrical shape, a flat shape, a thin shape, a coin shape, and the like. The secondary battery may be a secondary battery having a bipolar structure. For example, the secondary battery may be one that has a bipolar structure in which the electrode group has a positive electrode active material-containing layer on one side of a single current collector and a negative electrode active material-containing layer on the other side of the current collector. In this case, there is an advantage in that a plurality of cells in series can be formed of a single cell.

The secondary battery of the first embodiment includes: a plurality of positive electrodes each including a positive electrode current collector and a positive electrode tab, the positive electrode current collector including a first conductive material and a first polymeric material; a plurality of negative electrodes each including a negative electrode current collector and a negative electrode tab, the negative electrode current collector including a second conductive material and a second polymeric material; a positive electrode lead with which at least a portion of the positive electrode tab of each of the positive electrodes is in direct contact; a negative electrode lead with which at least a portion of the negative electrode tab of each of the negative electrodes is in direct contact; and an aqueous electrolyte. Thus, a secondary battery with suppressed side reactions and low resistance can be provided.

### Second Embodiment

According to a second embodiment, a battery pack is provided. The battery pack includes the secondary battery according to the first embodiment. The battery pack may include one secondary battery of the first embodiment or include a battery module constituted by a plurality of secondary batteries of the first embodiment.

The battery pack according to the second embodiment may further include a protective circuit. The protective circuit functions to control charge and discharge of the secondary battery. Alternatively, a circuit included in devices (such as electronic devices and automobiles) that use a battery pack as a power source may be used as the protective circuit of the battery pack.

The battery pack according to the second embodiment may further include an external power distribution terminal. The external power distribution terminal is configured to output current from the secondary battery to the outside and/or to input current to the secondary battery from the outside. In other words, when the battery pack is used as a power source, current is supplied to the outside via the external power distribution terminal. When the battery pack is to be charged, charging current (including regenerative energy of the motive force of automobiles and the like) is supplied to the battery pack via the external power distribution terminal.

Next, an example of the battery pack according to the second embodiment will be described with reference to the accompanying drawings.

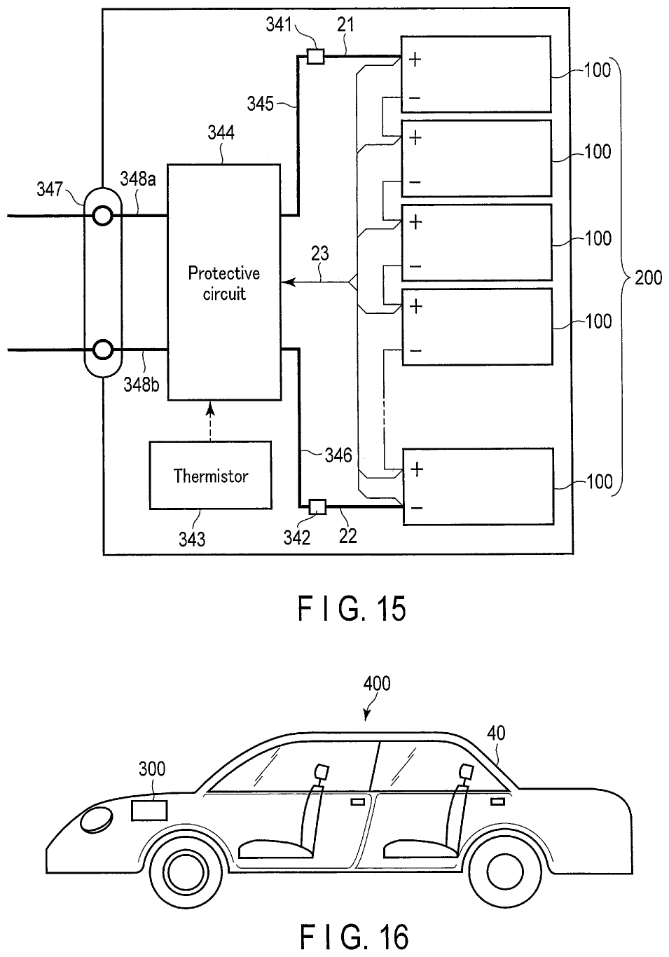

FIG. 15 is a block diagram showing an example of an electric circuit of the battery pack.

The battery pack shown in FIG. 15 includes a battery module 200 and a wire 23. The battery module 200 includes a plurality of unit cells 100, a positive electrode-side lead 21, a negative electrode-side lead 22, and a printed wiring board described later. At least one of the unit cells 100 is the secondary battery according to the first embodiment. The unit cells 100 are electrically connected to each other in series, as shown in FIG. 15. Alternatively, the unit cells 100 may be electrically connected in parallel or in a combination of in-series connection and in-parallel connection. When the unit cells 100 are connected in parallel, the battery capacity increases as compared to the case where the unit cells are connected in series.

An adhesive tape fastens the unit cells 100. A heat-shrinkable tape may be used instead of an adhesive tape to fix the unit cells 100. In this case, protective sheets are placed on both of the side surfaces of the battery module 200, and the heat-shrinkable tape is wound around the battery module 200 and then thermally shrunk, to thereby bind the unit cells 100.

One end of the positive electrode-side lead 21 is connected to the positive electrode terminal of the unit cell 100 positioned lowermost in the stack of the unit cells 100. One end of the negative electrode-side lead 22 is connected to the negative electrode terminal of the unit cell 100 positioned uppermost in the stack of the unit cells 100.

A printed wiring board includes a positive electrode-side connector 341, a negative electrode-side connector 342, a thermistor 343, a protective circuit 344, wires 345 and 346, an external power distribution terminal 347, a plus-side wire 348a, and a minus-side wire 348b.

The positive electrode-side connector 341 is provided with a through hole. Inserting the other end of the positive electrode-side lead 21 into the through hole electrically connects the positive electrode-side connector 341 and the positive electrode-side lead 21. The negative electrode-side connector 342 is provided with a through hole. Inserting the other end of the negative electrode-side lead 22 into the through hole electrically connects the negative electrode-side connector 342 and the negative electrode-side lead 22.

The thermistor 343 is fixed to one of the main surfaces of the printed wiring board. The thermistor 343 detects the temperature of each of the unit cells 100 and transmits the detection signals to the protective circuit 344.

The external power distribution terminal 347 is fixed to the other of the main surfaces of the printed wiring board. The external power distribution terminal 347 is electrically connected to a device(s) outside the battery pack.

The protective circuit 344 is fixed to the other of the main surfaces of the printed wiring board. The protective circuit 344 is connected to the external power distribution terminal 347 via the plus-side wire 348a. The protective circuit 344 is connected to the external power distribution terminal 347 via the minus-side wire 348b. The protective circuit 344 is also electrically connected to the positive electrode-side connector 341 via the wire 345. The protective circuit 344 is electrically connected to the negative electrode-side connector 342 via the wire 346. Further, the protective circuit 344 is electrically connected to each of the unit cells 100 via the wire 23.

The protective circuit 344 controls charge and discharge of the unit cells 100. The protective circuit 344 also cuts off an electric connection between the protective circuit 344 and the external power distribution terminal 347 based on a detection signal transmitted from the thermistor 343 or a detection signal transmitted from the individual unit cells 100 or the battery module 200.

An example of the detection signal transmitted from the thermistor 343 is a signal indicating that the temperatures of the unit cells 100 are detected to be a predetermined temperature or higher. An example of the detection signal transmitted from the individual unit cells 100 or the battery module 200 is a signal indicating detection of overcharge, overdischarge, and overcurrent of the unit cells 100. In the case of detecting overcharge, etc., of the individual unit cells 100, a battery voltage may be detected, or a positive electrode potential or a negative electrode potential may be detected. In the latter case, a lithium electrode used as a reference electrode is inserted into each unit cell 100.

A circuit included in devices (such as electronic devices and automobiles) that use a battery pack as a power source may be used as the protective circuit 344.

The battery pack also includes an external power distribution terminal 347, as described above. Thus, the battery pack can output current from the battery module 200 to an external device and input current from an external device to the battery module 200 via the external power distribution terminal 347. In other words, when using the battery pack as a power source, current from the battery module 200 is supplied to an external device via the external power distribution terminal 347. When charging the battery pack, charge current from an external device is supplied to the battery pack via the external power distribution terminal 347. If the battery pack is used as an in-vehicle battery, regenerative energy of the motive force of the vehicle can be used as the charge current from the external device.

The battery pack may include a plurality of battery modules 200. In this case, the plurality of battery modules 200 may be connected in series, in parallel, or in a combination of in-series connection and in-parallel connection. The printed wiring board and the wire 23 may be omitted. In this case, the positive electrode-side lead 21 and the negative electrode-side lead 22 may be used as the external power distribution terminal.

Such a battery pack is used, for example, in applications where excellent cycle performance is demanded when a large current is extracted. Specifically, the battery pack is used as a power source of electronic devices, a stationary battery, and an in-vehicle battery for various vehicles. An example of the electronic devices is a digital camera. The battery pack is particularly suitably used as an in-vehicle battery.

The battery pack according to the second embodiment includes the secondary battery according to the first embodiment. Thus, the battery pack according to the second embodiment can suppress side reactions and achieve low resistance.

### Third Embodiment

According to a third embodiment, a vehicle is provided. The vehicle includes the battery pack according to the second embodiment.

In the vehicle according to the third embodiment, the battery pack, for example, recovers regenerative energy of the motive force of the vehicle. The vehicle may include a mechanism configured to convert kinetic energy of the vehicle to regenerative energy.

Examples of the vehicle include two- to four-wheeled hybrid electric automobiles, two- to four-wheeled electric automobiles, power-assisted bicycles, and railway cars.

The place where the battery pack is installed in the vehicle is not particularly limited. For example, when installing the battery pack in an automobile, the battery pack can be installed in the engine compartment of the vehicle, in a rear part of the vehicle, or under a seat.

The vehicle may include a plurality of battery packs. In this case, the battery packs may be electrically connected in series, electrically connected in parallel, or electrically connected in a combination of in-series connection and in-parallel connection.

Next, an example of the vehicle according to the third embodiment will be described with reference to the accompanying drawings.

FIG. 16 is a cross-sectional view schematically showing an example of the vehicle according to the third embodiment.

A vehicle 400 shown in FIG. 16 includes a vehicle body 40 and the battery pack 300 according to the second embodiment. In the example shown in FIG. 16, the vehicle 400 is a four-wheeled automobile.

The vehicle 400 may include a plurality of battery packs 300. In this case, the battery packs 300 may be connected in series, connected in parallel, or connected in a combination of in-series connection and in-parallel connection.

FIG. 16 shows an example in which the battery pack 300 is installed in the engine compartment in front of the vehicle body 40. The battery pack 300 may be installed, for example, in a rear part of the vehicle body 40, or under a seat. The battery pack 300 may be used as a power source of the vehicle 400. The battery pack 300 can also recover regenerative energy of a motive force of the vehicle 400.

The vehicle according to the third embodiment includes the secondary battery or the battery pack according to the embodiment. Thus, the present embodiment can provide a vehicle including a secondary battery with few side reactions and low resistance.

### Fourth Embodiment

According to a fourth embodiment, a stationary power supply is provided. The stationary power supply includes the battery pack according to the embodiment. The stationary power supply may include the secondary battery according to the first embodiment or the battery module, instead of the battery pack according to the second embodiment.

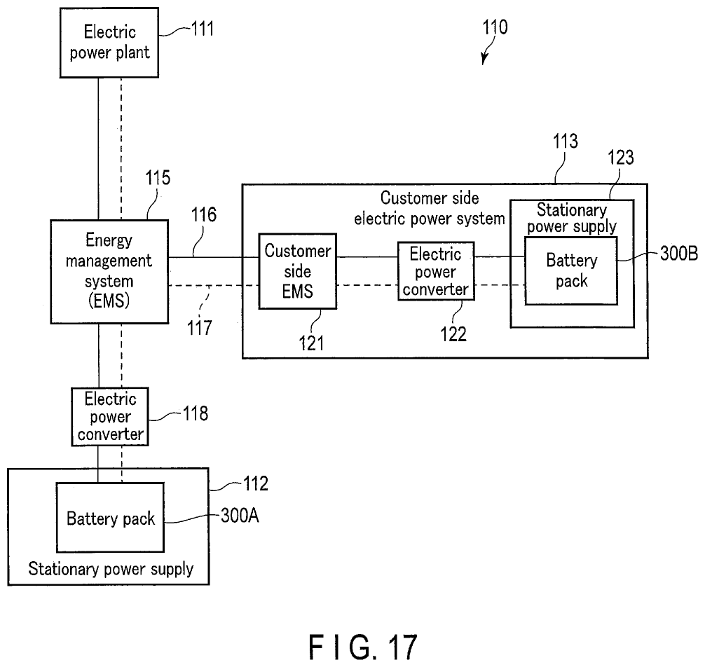

FIG. 17 is a block diagram showing an example of a system including the stationary power supply according to the fourth embodiment. FIG. 17 shows an example of application to stationary power supplies 112 and 123 as an example of use of the battery packs 300A and 300B according to the second embodiment. An example shown in FIG. 17 presents a system 110 which uses the stationary power supplies 112 and 123. The system 110 includes an electric power plant 111, the stationary power supply 112, a customer-side electric power system 113, and an energy management system (EMS) 115. An electric power network 116 and a communication network 117 are formed in the system 110, and the electric power plant 111, the stationary power supply 112, the customer-side electric power system 113, and the EMS 115 are connected via the electric power network 116 and the communication network 117. The EMS 115 utilizes the electric power network 116 and the communication network 117 to perform control to stabilize the entire system 110.

The electric power plant 111 generates a large amount of electric power from fuel sources such as thermal power and nuclear power. Electric power is supplied from the electric power plant 111 through the electric power network 116 and the like. The battery pack 300A is installed in the stationary power supply 112. The battery pack 300A can store electric power and the like supplied from the electric power plant 111. The stationary power supply 112 can also supply the electric power stored in the battery pack 300A through the electric power network 116 and the like. The system 110 is provided with an electric power converter 118. The electric power converter 118 includes a converter, an inverter, a transformer and the like. Thus, the electric power converter 118 can perform conversion between direct current and alternate current, conversion between alternate currents of different frequencies, voltage transformation (step-up and step-down), and the like. Accordingly, the electric power converter 118 can convert electric power from the electric power plant 111 into electric power that can be stored in the battery pack 300A.

The customer-side electric power system 113 includes an electric power system for factories, an electric power system for buildings, an electric power system for home use, and the like. The customer-side electric power system 113 includes a customer-side EMS 121, an electric power converter 122, and the stationary power supply 123. The battery pack 300B is installed in the stationary power supply 123. The customer-side EMS 121 performs control to stabilize the customer-side electric power system 113.

Electric power from the electric power plant 111 and electric power from the battery pack 300A are supplied to the customer-side electric power system 113 through the electric power network 116. The battery pack 300B can store electric power supplied to the customer-side electric power system 113. Similarly to the electric power converter 118, the electric power converter 122 includes a converter, an inverter, a transformer and the like. Thus, the electric power converter 122 can perform conversion between direct current and alternate current, conversion between alternate currents of different frequencies, voltage transformation (step-up and step-down), and the like. Accordingly, the electric power converter 122 can convert electric power supplied to the customer-side electric power system 113 into electric power that can be stored in the battery pack 300B.

The electric power stored in the battery pack 300B can be used, for example, for charging a vehicle such as an electric automobile. The system 110 may also be provided with a natural energy source. In this case, the natural energy source generates electric power from natural energy such as wind power and solar light. In addition to the electric power plant 111, electric power is also supplied from the natural energy source through the electric power network 116.

The stationary power supply according to the fourth embodiment includes the secondary battery according to the embodiment. Thus, the present embodiment can provide a stationary power supply including a secondary battery with suppressed side reactions and low resistance.

### EXAMPLES

Examples will be described below; however, the embodiments are not limited to these examples.

### Example 1

<Production of Negative Electrode>

Particles of a titanium composite oxide having a composition represented by Li₄Ti₅O₁₂ were provided as a negative electrode active material. Acetylene black (AB) as a conductive agent, and polyvinylidene fluoride (PVdF) as a binder were provided. They were mixed together in an n-methylpyrrolidone (NMP) at a mass ratio of negative electrode active material:AB:PVdF of 90:5:5, to obtain a slurry. The obtained slurry was applied onto both of the front and back main surfaces of the negative electrode current collector, excluding the portion to be a negative electrode tab, and the coating was dried, whereby a negative electrode active material-containing layer was formed. A conductive resin sheet which was made of 70% by mass of a matrix component made of polypropylene (PP) and 30% by mass of carbon black (CB) as a conductive filler, and which had a thickness of 40 μm was prepared as the negative electrode current collector. The negative electrode tab extended, in the second direction, from two portions of an edge of the negative electrode current collector along the short-side direction. An amount of coating per face of the negative electrode active material-containing layer was 50 g/m².

After the negative electrode active material-containing layer was dried, the negative electrode active material-containing layer on the negative electrode current collector was roll-pressed, so that the density of the negative electrode active material-containing layer became 2.0 g/cm³. Next, the resultant composite was vacuum-dried, thereby obtaining a negative electrode.

<Production of Positive Electrode>

Particles of a lithium nickel cobalt manganese composite oxide represented by LiNi_{0.33}Co_{0.33}Mn_{0.34}O₂ (represented as NCM333 in Table 1) were provided as a positive electrode active material. Acetylene black (AB) as a conductive agent and polyvinylidene fluoride (PVdF) as a binder were provided. They were mixed together at a mass ratio of positive electrode active material:AB:PVdF of 90:5:5, to obtain a mixture. Next, the obtained mixture was dispersed in an n-methylpyrrolidone (NMP) solvent to prepare a positive electrode slurry. The slurry thus prepared was applied onto both main surfaces of the positive electrode current collector, excluding the portion to be a positive electrode tab, and the coating was dried, whereby a positive electrode active material-containing layer was formed. A conductive resin sheet which was made of 70% by mass of a matrix component made of polypropylene (PP) and 30% by mass of carbon black (CB) as a conductive filler, and had a thickness of 40 μm was prepared as the positive electrode current collector. The positive electrode tab extended, in the first direction, from two portions of an edge of the positive electrode current collector along the short-side direction. An amount of coating per face of the positive electrode active material-containing layer was 50 g/m².

After the positive electrode active material-containing layer was dried, the positive electrode active material-containing layer on the positive electrode current collector was roll-pressed, so that the density of the positive electrode active material-containing layer became 3.0 g/cm³. Next, the resultant composite was vacuum-dried, thereby obtaining a positive electrode.

<Production of Electrode Group>

A separator made of a polyethylene (PE) porous film having a thickness of 15 μm and a layer including alumina particles and formed on both sides of the polyethylene (PE) porous film was prepared. The layer including alumina particles had a thickness of 3 nm. Next, the separator thus prepared and the negative electrode and positive electrode obtained above were stacked in the order of the negative electrode, the separator, the positive electrode, and the separator, to obtain an electrode group made of a stack. Four negative electrodes were used, and were defined as a first negative electrode, a second negative electrode, a third negative electrode, and a fourth negative electrode, respectively, from the upper layer side of the electrode group. Three positive electrodes were used, and were defined as a first positive electrode, a second positive electrode, and a third positive electrode, respectively, from the upper layer side of the electrode group. The extending direction of the negative electrode tab was the second direction along the x-axis shown in FIG. 2. The extending direction of the positive electrode tab was the first direction, opposite to the second direction, along the x-axis shown in FIG. 2.

A strip-shaped aluminum plate having a thickness of 200 μm was prepared as each of the negative electrode lead and the positive electrode lead.

As shown in FIG. 7, the negative electrode tab 6₁ of the first negative electrode 8, the negative electrode tab 6₂ of the first negative electrode 8, the negative electrode tab 6₃ of the second negative electrode 8, and the negative electrode tab 6₄ of the second negative electrode 8 were arranged on the upper side of the first connection face 4a of the negative electrode lead 4 with a space provided between each of the tabs. Excluding the negative electrode tab 6₁ of the first negative electrode 8, the remaining three negative electrode tabs, the negative electrode tab 6₂ of the first negative electrode 8, the negative electrode tab 6₃ of the second negative electrode 8, and the negative electrode tab 6₄ of the second negative electrode 8, were bonded to the first connection face 4a of the negative electrode lead 4 by thermally fusing the PP included in the tabs. The thermal fusion bonding was performed by heating the tabs to 150° C. The negative electrode tab 6₁ is not in contact with the first connection face 4a of the negative electrode lead 4.

As shown in FIG. 8, the negative electrode tab 6₅ of the third negative electrode 8, the negative electrode tab 6₆ of the third negative electrode 8, the negative electrode tab 6₇ of the fourth negative electrode 8, and the negative electrode tab 6₈ of the fourth negative electrode 8 were arranged on the upper side of the second connection face 4b of the negative electrode lead 4 with a space provided between each of the tabs. These four negative electrode tabs were bonded to the second connection face 4b of the negative electrode lead 4 by thermally fusing the PP included in the tabs.

With regard to the positive electrode, the positive electrode tab 7₁ of the first positive electrode 9, the positive electrode tab 7₂ of the first positive electrode 9, the positive electrode tab 7₃ of the second positive electrode 9, and the positive electrode tab 7₄ of the second positive electrode 9 were arranged on the upper side of the first connection face 5a of the positive electrode lead 5 with a space provided between each of the tabs, as shown in FIG. 9. Excluding the positive electrode tab 7₁ of the first positive electrode 9, the remaining three positive electrode tabs, the positive electrode tab 7₂, the positive electrode tab 7₃, and the positive electrode tab 7₄ were bonded onto the first connection face 5a of the positive electrode lead 5 by thermally fusing the PP included in the tabs. The thermal fusion bonding was performed by heating the tabs to 150° C. The positive electrode tab 7₁ is not in contact with the first connection face 5a of the positive electrode lead 5.

As shown in FIG. 10, the positive electrode tab 7₅ and the positive electrode tab 7₆ of the third positive electrode 9 were arranged on the upper side of the second connection face 5b of the positive electrode lead 5 with a space provided between the tabs. These two positive electrode tabs 7₅ and 7₆ were bonded onto the first connection face 5a of the positive electrode lead 5 by thermally fusing the PP included in the tabs.

An electrode group thus produced was covered with a container member made of an aluminum-containing laminated film with an inlet. Next, after injecting an aqueous electrolyte from the inlet, the inlet was closed to thereby seal the container member in a liquid-tight manner. As the aqueous electrolyte, an electrolytic solution made of an aqueous solution containing lithium chloride (LiCl) was prepared. The concentration of the lithium chloride in the aqueous solution was 12 mol/L.

A secondary battery of Example 1 was produced as described above.

### Example 2

A secondary battery was produced in the same manner as described in Example 1 except that the way of connecting the positive and negative electrode tabs with the positive and negative electrode leads was changed as described below.

As shown in FIG. 7, the negative electrode tab 6₁ of the first negative electrode 8, the negative electrode tab 6₂ of the first negative electrode 8, the negative electrode tab 6₃ of the second negative electrode 8, and the negative electrode tab 6₄ of the second negative electrode 8 were arranged on the upper side of the first connection face 4a of the negative electrode lead 4 with a space provided between each of the tabs. As shown in FIG. 20, the negative electrode tab 6₂ and the negative electrode tab 6₃ adjacent to each other were bonded to the first connection face 4a of the negative electrode lead 4 by thermal fusion bonding under the same conditions as described in Example 1. As shown in FIG. 20, the negative electrode tab 6₁ and the negative electrode tab 6₄ positioned with the negative electrode tab 6₂ and the negative electrode tab 6₃ interposed therebetween were not in contact with the first connection face 4a of the negative electrode lead 4.

As shown in FIG. 8, the negative electrode tab 6₅ of the third negative electrode 8, the negative electrode tab 6₆ of the third negative electrode 8, the negative electrode tab 6₇ of the fourth negative electrode 8, and the negative electrode tab 6₈ of the fourth negative electrode 8 were arranged on the upper side of the second connection face 4b of the negative electrode lead 4 with a space provided between each of the tabs. As shown in FIG. 20, the negative electrode tab 6₆ and the negative electrode tab 6₇ adjacent to each other were bonded to the second connection face 4b of the negative electrode lead 4 by thermal fusion bonding under the same conditions as described in Example 1. As shown in FIG. 20, the negative electrode tab 6₅ and the negative electrode tab 6₈ positioned with the negative electrode tab 6₆ and the negative electrode tab 6₇ interposed therebetween were not in contact with the second connection face 4b of the negative electrode lead 4.

In the above-described manner, one of the two negative electrode tabs of each negative electrode was electrically connected to the negative electrode lead, and the other of the two negative electrode tabs of each negative electrode was not bonded to the negative electrode lead.

With regard to the positive electrode, the positive electrode tab 7₁ of the first positive electrode 9, the positive electrode tab 7₂ of the first positive electrode 9, the positive electrode tab 7₃ of the second positive electrode 9, and the positive electrode tab 7₄ of the second positive electrode 9 were arranged on the upper side of the first connection face 5a of the positive electrode lead 5 with a space provided between each of the tabs, as shown in FIG. 9. The positive electrode tab 7₂ and the positive electrode tab 7₃ adjacent to each other with a space therebetween were bonded onto the first connection face 5a of positive electrode lead 5 by thermal fusion bonding under the same conditions as described in Example 1. The positive electrode tab 7₁ and the positive electrode tab 7₄ positioned with the positive electrode tab 7₂ and the positive electrode tab 7₃ interposed therebetween were not in contact with the first connection face 5a of the positive electrode lead 5.

As shown in FIG. 10, the positive electrode tab 7₅ and the positive electrode tab 7₆ of the third positive electrode 9 were arranged on the upper side of the second connection face 5b of the positive electrode lead 5 with a space provided between the tabs. The positive electrode tab 7₆ was bonded onto the second connection face 5b of the positive electrode lead 5 by thermal fusion bonding under the same conditions as described in Example 1. On the other hand, the positive electrode tab 7₅ was not in contact with the second connection face 5b of the positive electrode lead 5.

In the above-described manner, one of the two positive electrode tabs of each positive electrode was electrically connected to the positive electrode lead, and the other of the two positive electrode tabs of each positive electrode was not bonded to the positive electrode lead.

### Example 3

A secondary battery was produced in the same manner as described in Example 1 except that the way of connecting the positive and negative electrode tabs with the positive and negative electrode leads was changed as described below.

First, in the same manner as described in Example 2, one of the two negative electrode tabs of each negative electrode was electrically connected to the negative electrode lead, and the other of the two negative electrode tabs of each negative electrode was not bonded to the negative electrode lead.

Also, in the same manner as described in Example 2, one of the two positive electrode tabs of each positive electrode was electrically connected to the positive electrode lead, and the other of the two positive electrode tabs of each positive electrode was not bonded to the positive electrode lead.

On the first connection face 4a of the negative electrode lead 4, an edge of the negative electrode tab 6₃ along the second direction was placed on top of an edge of the negative electrode tab 6₂ along the second direction, to provide the first connecting portion 13 that electrically connects the negative electrode tab 6₂ and the negative electrode tab 6₃, as shown in FIG. 11. On the second connection face 4b of the negative electrode lead 4, an edge of the negative electrode tab 6₇ along the second direction was placed on top of an edge of the negative electrode tab 6₆ along the second direction, to provide the second connecting portion 14 that electrically connects the negative electrode tab 6₆ and the negative electrode tab 6₇, as shown in FIG. 12.

On the first connection face 5a of the positive electrode lead 5, an edge of the positive electrode tab 7₃ along the first direction was placed on top of an end of the positive electrode tab 7₂ along the first direction, to provide the third connecting portion 15 that electrically connects the positive electrode tab 7₂ and the positive electrode tab 7₃, as shown in FIG. 13.

A secondary battery of Example 3 was produced as described above.

### Comparative Example 1

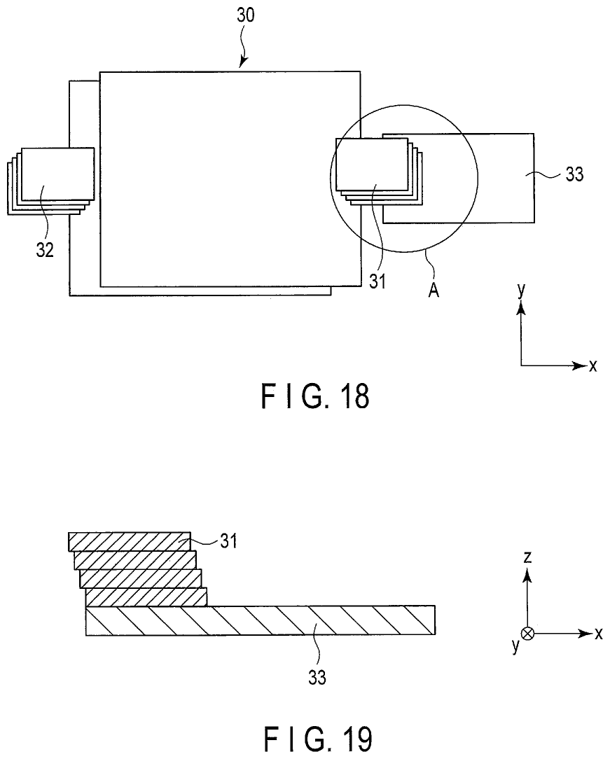

A secondary battery of Comparative Example 1 having the structure shown in FIGS. 18 and 19 was produced by the method described below. FIG. 18 is a schematic view of an electrode group of the secondary battery of the comparative example, and FIG. 19 is a cross-sectional view of the portion A in FIG. 18, taken along the stacking direction.

<Production of Negative Electrode>

A slurry having the same composition as described in Example 1 was applied onto both of the main surfaces of the negative electrode current collector, excluding the portion to be a negative electrode tab, and the coating was dried, whereby a negative electrode active material-containing layer was formed. An aluminum foil having a thickness of 15 μm was provided as the negative electrode current collector. The negative electrode tab extended, in the second direction, from one portion of an edge of the negative electrode current collector along the short-side direction. An amount of coating per face of the negative electrode active material-containing layer was 50 g/m².

After the negative electrode active material-containing layer was dried, the negative electrode active material-containing layer on the negative electrode current collector was roll-pressed, so that the density of the negative electrode active material-containing layer became 2.0 g/cm³. Next, the resultant composite was vacuum-dried, thereby obtaining a negative electrode.

<Production of Positive Electrode>

A slurry having the same composition as described in Example 1 was applied onto both of the main surfaces of the positive electrode current collector, excluding the portion to be a positive electrode tab, and the coating was dried, whereby a positive electrode active material-containing layer was formed. An aluminum foil having a thickness of 15 μm was provided as the positive electrode current collector. The positive electrode tab extended, in the first direction, from one portion of an edge of the positive electrode current collector along the short-side direction. An amount of coating per face of the positive electrode active material-containing layer was 50 g/m².

After the positive electrode active material-containing layer was dried, the positive electrode active material-containing layer on the positive electrode current collector was roll-pressed, so that the density of the positive electrode active material-containing layer became 3.0 g/cm³. Next, the resultant composite was vacuum-dried, thereby obtaining a positive electrode.

<Production of Electrode Group>

The above negative electrode, the above positive electrode, and the same separator as prepared in Example 1 were stacked in the order of the negative electrode, the separator, the positive electrode, and the separator, to obtain an electrode group 30 made of a stack. Four negative electrodes were used. Three positive electrodes were used. The extending direction of the negative electrode tab 31 was the second direction along the x-axis shown in FIG. 18. The extending direction of the positive electrode tab 32 was the first direction along the x-axis shown in FIG. 18.

The same strip-shaped aluminum plate as described in Example 1 was prepared as each of the negative electrode lead and the positive electrode lead.

As shown in FIG. 19, a stack of four negative electrode tabs 31, the negative electrode tabs 31 being stacked in the z-axis direction, was arranged on the negative electrode lead 33 and connected thereto by ultrasonic welding. A stack of three positive electrode tabs 32, the positive electrode tabs 32 being stacked in the z-axis direction, was arranged on the positive electrode lead and connected thereto by ultrasonic welding.

An electrode group thus produced was covered with a container member made of an aluminum-containing laminated film with an inlet. Next, after injecting an aqueous electrolyte having the same composition as described in Example 1 from the inlet, the inlet was closed to thereby seal the container member in a liquid-tight manner. A secondary battery of Comparative Example 1 was produced as described above.

### Comparative Example 2

A secondary battery of Comparative Example 2 having the structure shown in FIGS. 18 and 19 was produced by the method described below.

<Production of Negative Electrode>

A slurry having the same composition as described in Example 1 was applied onto both of the main surfaces of the negative electrode current collector, excluding the portion to be a negative electrode tab, and the coating was dried, whereby a negative electrode active material-containing layer was formed. The same resin sheet as described in Example 1 was prepared as the negative electrode current collector. The negative electrode tab extended, in the second direction, from one portion of an edge of the negative electrode current collector along the short-side direction. An amount of coating per face of the negative electrode active material-containing layer was 50 g/m².

After the negative electrode active material-containing layer was dried, the negative electrode active material-containing layer on the negative electrode current collector was roll-pressed, so that the density of the negative electrode active material-containing layer became 2.0 g/cm³. Next, the resultant composite was vacuum-dried, thereby obtaining a negative electrode.

<Production of Positive Electrode>

A slurry having the same composition as described in Example 1 was applied onto both of the main surfaces of the positive electrode current collector, excluding the portion to be a positive electrode tab, and the coating was dried, whereby a positive electrode active material-containing layer was formed. The same resin sheet as described in Example 1 was prepared as the positive electrode current collector. The positive electrode tab extended, in the first direction, from one portion of an edge of the positive electrode current collector along the short-side direction. An amount of coating per face of the positive electrode active material-containing layer was 50 g/m².

After the positive electrode active material-containing layer was dried, the positive electrode active material-containing layer on the positive electrode current collector was roll-pressed, so that the density of the positive electrode active material-containing layer became 3.0 g/cm³. Next, the resultant composite was vacuum-dried, thereby obtaining a positive electrode.

<Production of Electrode Group>

The above negative electrode, the above positive electrode, and the same separator as prepared in Example 1 were stacked in the order of the negative electrode, the separator, the positive electrode, and the separator, to obtain an electrode group 30 made of a stack. Four negative electrodes were used. Three positive electrodes were used. The extending direction of the negative electrode tab 31 was the second direction along the x-axis shown in FIG. 18. The extending direction of the positive electrode tab 32 was the first direction along the x-axis shown in FIG. 18.

The same strip-shaped aluminum plate as described in Example 1 was prepared as each of the negative electrode lead and the positive electrode lead.

As shown in FIG. 19, a stack of four negative electrode tabs 31, the negative electrode tabs 31 being stacked in the z-axis direction, was arranged on the negative electrode lead 33 and connected thereto by thermal fusion bonding. A stack of three positive electrode tabs 32, the positive electrode tabs 32 being stacked in the z-axis direction, was arranged on the positive electrode lead and connected thereto by thermal fusion bonding.

An electrode group thus produced was covered with a container member made of an aluminum-containing laminated film with an inlet. Next, after injecting an aqueous electrolyte having the same composition as described in Example 1 from the inlet, the inlet was closed to thereby seal the container member in a liquid-tight manner. A secondary battery of Comparative Example 2 was produced as described above.

A capacity retention after 100 cycles at 25° C. and 0.5 C was measured as cycle performance of the produced battery. Charging was performed by a constant-current constant-voltage system at a current value of 0.5 C and a voltage of 2.6 V. The time needed till termination of charge was 150 minutes. Discharge was performed by a constant current system at a current value of 0.5 C and a discharge termination voltage of 1.5 V. A quiescent period after termination of charge and termination of discharge was not set. Table 1 shows the results of the measurement.

| | Negative | Negative | Positive | Positive | | | |
|---|---|---|---|---|---|---|---|
| | Electrode | Electrode | Electrode | Electrode | | | Cycle Capacity |
| | Active | Current | Active | Current | Positive/Negative | | Retention |
| | Material | Collector | Material | Collector | Electrode Tabs | Non-connection | (%) |
| Example 1 | Li₄Ti₅O₁₂ | PP + CB | NCM333 | PP + CB | 2 | One Portion of | 86 |
| | | | | | | Single Tab | |
| Example 2 | Li₄Ti₅O₁₂ | PP + CB | NCM333 | PP + CB | 2 | One Portion of | 81 |
| | | | | | | Each Tab | |
| Example 3 | Li₄Ti₅O₁₂ | PP + CB | NCM333 | PP + CB | 2 | One Portion of | 83 |
| | | | | | | Each Tab | |
| Comparative | Li₄Ti₅O₁₂ | Al | NCM333 | Al | 1 | — | 70 |
| Example 1 | | | | | | | |
| Comparative | Li₄Ti₅O₁₂ | PP + CB | NCM333 | PP + CB | 1 | — | 72 |
| Example 2 | | | | | | | |

As is apparent from Table 1, the cycle capacity retention of the secondary batteries of Examples 1 to 3 was more excellent than the cycle capacity retention of the secondary batteries of Comparative Examples 1 and 2. This is because the secondary batteries of Examples 1 to 3 suppress an electrolysis reaction of water and have low resistance. On the other hand, the cycle life of the secondary battery of Comparative Example 1 was shortened due to a decrease in the coulombic efficiency caused by an electrolysis of water. In the secondary battery of Comparative Example 2, although an electrolysis of water was suppressed, the resistance of the battery was high and the cycle life became short.

A comparison among Examples 1 to 3 reveals that Example 1, which had the largest number of tabs that were in direct contact with the lead, exhibited a high capacity retention.

The secondary battery of at least one embodiment described above includes: positive electrodes each including a positive electrode current collector and a positive electrode tab, the positive electrode current collector including a first conductive material and a first polymeric material; negative electrodes each including a negative electrode current collector and a negative electrode tab, the negative electrode current collector including a second conductive material and a second polymeric material; a positive electrode lead with which at least a portion of the positive electrode tab of each of the positive electrodes is in direct contact; a negative electrode lead with which at least a portion of the negative electrode tab of each of the negative electrodes is in direct contact; and an aqueous electrolyte. Thus, a secondary battery with suppressed side reactions and low resistance can be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A secondary battery comprising:
positive electrodes each comprising: a positive electrode current collector; a positive electrode tab extending, along a first direction, from at least one portion of an edge of the positive electrode current collector; and a positive electrode active material-containing layer provided on at least a portion of a surface of the positive electrode current collector, and the positive electrode current collector comprising a first conductive material and a first polymeric material;
negative electrodes each comprising: a negative electrode current collector; a negative electrode tab extending, along a second direction, from at least one portion of an edge of the negative electrode current collector; and a negative electrode active material-containing layer provided on at least a portion of a surface of the negative electrode current collector, and the negative electrode current collector comprising a second conductive material and a second polymeric material;
a separator between the positive electrodes and the negative electrodes;
a positive electrode lead with which at least a portion of the positive electrode tab of each of the positive electrodes is in direct contact;
a negative electrode lead with which at least a portion of the negative electrode tab of each of the negative electrodes is in direct contact; and
an aqueous electrolyte.

2. The secondary battery according to claim 1, wherein
the positive electrode tab comprises extending portions extending, along the first direction, from portions of the edge of the positive electrode current collector,
at least one of the extending portions of the positive electrode tab of each of the positive electrodes is in direct contact with the positive electrode lead,
the negative electrode tab comprises extending portions extending, along the second direction, from portions of the edge of the negative electrode current collector, and
at least one of the extending portions of the negative electrode tab of each of the negative electrodes is in direct contact with the negative electrode lead.

3. The secondary battery according to claim 1, wherein
at least a portion of the positive electrode tab of one positive electrode of the positive electrodes is in direct contact with the positive electrode lead,
at least a portion of the positive electrode tab of another positive electrode of the positive electrodes is in direct contact with the positive electrode lead,
a connecting portion is provided between the positive electrode tab of the one positive electrode on the positive electrode lead and the positive electrode tab of the another positive electrode on the positive electrode lead, the connecting portion electrically connecting the positive electrode tab of the one positive electrode and the positive electrode tab of the another positive electrode,
at least a portion of the negative electrode tab of one negative electrode of the negative electrodes is in direct contact with the negative electrode lead,
at least a portion of the negative electrode tab of another negative electrode of the negative electrodes is in direct contact with the negative electrode lead, and
a connecting portion is provided between the negative electrode tab of the one negative electrode on the negative electrode lead and the negative electrode tab of the another negative electrode on the negative electrode lead, the connecting portion electrically connecting the negative electrode tab of the one negative electrode and the negative electrode tab of the another negative electrode.

4. The secondary battery according to claim 1, wherein
the positive electrode tab of each of one positive electrode and another positive electrode of the positive electrodes comprises extending portions extending, along the first direction, from portions of the edge of the positive electrode current collector,
at least one of the extending portions of the positive electrode tab of the one positive electrode is in direct contact with the positive electrode lead;
at least one of the extending portions of the positive electrode tab of the another positive electrode is in direct contact with the positive electrode lead,
a connecting portion is provided between the extending portions of the one positive electrode on the positive electrode lead and the extending portions of the another positive electrode on the positive electrode lead, the connecting portion electrically connecting the extending portions of the one positive electrode and the extending portions of the another positive electrode,
the negative electrode tab of each of one negative electrode and another negative electrode of the negative electrodes comprises extending portions extending, along the second direction, from portions of the edge of the negative electrode current collector,
at least one of the extending portions of the negative electrode tab of the one negative electrode is in direct contact with the negative electrode lead,
at least one of the extending portions of the negative electrode tab of the another negative electrode is in direct contact with the negative electrode lead, and
a connecting portion is provided between the extending portions of the one negative electrode on the negative electrode lead and the extending portions of the another negative electrode on the negative electrode lead, the connecting portion electrically connecting the extending portions of the one negative electrode and the extending portions of the another negative electrode.

5. The secondary battery according to claim 3, wherein the connecting portion is formed by at least one selected from contact, thermal fusion bonding, and a conductive adhesive.

6. The secondary battery according to claim 1, wherein
the positive electrode current collector is a conductive resin sheet comprising: a matrix component made of the first polymeric material; and a filler mixed in the matrix component and made of the first conductive material; and
the negative electrode current collector is a conductive resin sheet comprising: a matrix component made of the second polymeric material; and a filler mixed in the matrix component and made of the second conductive material.

7. The secondary battery according to claim 1, wherein the positive electrode lead either comprises at least one selected from the group consisting of Ti, stainless steel, Al, and a carbonaceous material, or is formed of a same material as a material of the positive electrode current collector.

8. The secondary battery according to claim 1, wherein the negative electrode lead either comprises at least one selected from the group consisting of Al, Zn, Sn, Ni, Cu, and a carbonaceous material, or is formed of a same material as a material of the negative electrode current collector.

9. The secondary battery according to claim 1, wherein the negative electrode active material-containing layer comprises a niobium titanium composite oxide.

10. The secondary battery according to claim 1, wherein the aqueous electrolyte comprises an aqueous solvent and alkali metal ions.

11. A battery pack comprising the secondary battery according to claim 1.

12. The battery pack according to claim 11 further comprising an external power distribution terminal and a protective circuit.

13. The battery pack according to claim 11, comprising a plurality of the secondary battery,
wherein the secondary batteries are electrically connected in series, in parallel, or in a combination of in-series connection and in-parallel connection.

14. A vehicle comprising the secondary battery according to claim 1.

15. A stationary power supply comprising the secondary battery according to claim 1.
